(19) United States
(12) Patent Application Publication
(10) Pub. No.: US 2023/0148638 A1
(43) Pub. Date: May 18, 2023

(54) PONGAMIA OIL COMPOSITIONS, AND METHODS FOR PRODUCING AND USING THEREOF

(71) Applicant: Terviva, Inc., Oakland, CA (US)

(72) Inventors: James D. ASTWOOD, Alameda, CA (US); William Newell KUSCH, Oakland, CA (US); Vamsi Krishna RANI, Oakland, CA (US); Olivier R. RAFFRAY, Savannah, GA (US)

(73) Assignee: Terviva, Inc., Oakland, CA (US)

(21) Appl. No.: 17/916,529

(22) PCT Filed: Apr. 2, 2021
(86) PCT No.: PCT/US2021/025578

§ 371 Date: Sep. 30, 2022

Related U.S. Application Data
(60) Provisional application No. 63/004,790, filed on Apr. 3, 2020.

(51) Int. Cl. A23L 11/00; A23D 9/007; A23D 9/02; A23L 11/30

(52) U.S. Cl. CPC A23L 11/05; A23D 9/007; A23D 9/02; A23L 11/32

(57) ABSTRACT

Provided herein are Pongamia oil compositions suitable for animal consumption, in particular human consumption, as well as methods of producing such compositions. The compositions are edible and non-bitter tasting, and have certain attributes that make such compositions suitable for use as and/or in various food and beverage products. Provided herein are also methods of analyzing Pongamia oil.

### CROSS-REFERENCE(S) TO RELATED APPLICATION(S)

This application claims priority to and the benefit of U.S. Provisional Application No. 63/004,790, filed on Apr. 3, 2020, the entire disclosure of which is incorporated herein by reference in its entirety.

### FIELD

The present disclosure relates generally to Pongamia compositions, and more specifically, edible and non-bitter tasting Pongamia oil, as well as methods for producing thereof, and methods for using thereof in food and beverage products.

### BACKGROUND

Growing concerns related to population growth, climate change and the viability of existing agricultural practices over the next several decades have led to a surge in the research and development of alternative food sources to ensure future global food security. Renewable plant-based sources have prompted significant interest as an environmentally friendly and sustainable means to alleviate pressure on the worldwide food supply.

Millettia pinnata, also known as Pongamia pinnata or Pongamia glabra, or more colloquially as Pongamia or karanja, is tree that is common throughout Asia and may provide a major source for future plant-based food. Pongamia trees use a fraction of the land as required for soybean plants to produce the same amount of beans. Pongamia trees can grow on degraded soil, and allow for avoidance of deforestation issues created by soybeans. Pongamia also produces much larger amounts of protein and vegetable oil per acre than soybean. Pongamia oil, extracted from Pongamia oilseeds, offers a potential renewable source of oil for use in foodstuffs comparable to soy. However, Pongamia oilseeds also have other components that are known in the art to have disagreeable taste and odor, including karanjin and pongamol. It is desirable to minimize the amount of karanjin and pongamol in the oil for use as a viable food source.

The widespread use of Pongamia-derived foodstuffs is currently prevented by the absence of methods for preparing Pongamia compositions having low levels of karanjin and pongamol while maintaining the high nutritional content (proteins, carbohydrates, etc.) intrinsic to the oilseeds. Existing methods for the removal of these undesirable components in Pongamia seedcake and oil are insufficient and often require harsh, destructive conditions that reduce and degrade the nutrients to the point that the nutritional value of Pongamia is severely impacted. The lack of methods for producing Pongamia compositions having the critical balance of preserved nutritional content and sufficiently low levels of anti-nutrients have precluded the incorporation of Pongamia-derived oil on a large enough scale to remain economically feasible.

Thus, what is desired in the art are commercially viable methods to obtain edible compositions from Pongamia oilseeds that retain an optimal nutritional balance, while minimizing components such as karanjin and pongamol.

### BRIEF SUMMARY

In some aspects, provided herein are Pongamia oil compositions that are edible and non-bitter tasting. Such Pongamia oil compositions can serve as useful ingredients in a variety of food and beverage products, and address the substantial unmet need in the industry for emerging plant-based products.

In certain aspects, provided are methods for producing a Pongamia oil composition using solid-liquid separation. In some embodiments, the method comprises: mechanically separating dehulled Pongamia oilseeds to produce crude Pongamia oil and a seedcake that is at least partially deoiled, wherein the crude Pongamia oil comprises Pongamia oil, karanjin, pongamol, other furanoflavonoids, and other unsaponifiable matter; and extracting the crude Pongamia oil with an immiscible solvent at an elevated temperature to produce the Pongamia oil composition, wherein the ratio of solvent to crude Pongamia oil is between 1:1 and 20:1, and wherein the composition is edible and non-bitter tasting, has less than 150 ppm of karanjin and/or pongamol, and has less than 1% of unsaponifiable matter.

In certain embodiments, the method comprises: a) mechanically separating dehulled Pongamia oilseeds to produce crude Pongamia oil and a seedcake that is at least partially deoiled, wherein the crude Pongamia oil comprises Pongamia oil, karanjin, pongamol, other furanoflavonoids, and other unsaponifiable matter; b) combining the crude Pongamia oil with an immiscible solvent at an elevated temperature to form a mixture; c) allowing the mixture to settle, at the elevated temperature, into at least a Pongamia oil layer and a solvent layer; d removing the solvent layer from step c), at the elevated temperature, to isolate the Pongamia oil layer, wherein the Pongamia oil layer comprises edible and non-bitter tasting Pongamia oil. In some embodiments, the method further comprises: cooling the Pongamia oil layer from step c); allowing the Pongamia oil layer to settle into at least a Pongamia layer and a solvent layer; and removing the solvent layer to isolate the Pongamia oil layer, wherein the Pongamia oil layer comprises edible and non-bitter tasting Pongamia oil. In some variations, the method further comprises repeating steps b)-d) by combining the isolated Pongamia oil layer with fresh immiscible solvent.

In other aspects, provided is a continuous countercurrent method for producing a Pongamia oil composition, comprising: a) mechanically separating dehulled Pongamia oilseeds to produce crude Pongamia oil and a seedcake that is at least partially deoiled, wherein the crude Pongamia oil comprises Pongamia oil, karanjin, pongamol, other furanoflavonoids, and other unsaponifiable matter; b) separating the crude Pongamia oil into a raffinate and a solvent-rich light phase by liquid-liquid extraction using an immiscible solvent at an elevated temperature, wherein the ratio of solvent to crude Pongamia oil is between 1:1 and 20:1, wherein the raffinate comprises Pongamia oil and residual solvent, and wherein the solvent-rich light phase comprises solvent and residual Pongamia oil; c) cooling the raffinate to separate the residual solvent from Pongamia oil; d) isolating at least a portion of the Pongamia oil in the cooled raffinate to produce the Pongamia oil composition, wherein the composition is edible and non-bitter tasting, has less than or equal to 150 ppm of karanjin and/or pongamol, and has less than 1% of unsaponifiable matter; e) isolating at least a portion of the solvent from the solvent-rich light phase; and f) combining the isolated solvent with additional crude Pongamia oil for liquid-liquid extraction.

In one aspect, provided is a Pongamia oil composition produced according to any of the methods described herein. In other aspects, provided is a Pongamia oil composition that is edible and non-bitter tasting.

In other aspects, provided are uses of the Pongamia oil compositions in food or beverage products. In some variations, the Pongamia oil compositions may be used as or in salad oil, frying oil, sauteeing oil, vinaigrettes, sauces, dressings, fats in meat mimetics, beverages, or blended margarines and other solid fat applications.

In other aspects, provided is an analytical method to measure the content of karanjin and pongamol that may be present in a Pongamia oil sample. In some embodiments, the method comprises: combining Pongamia oil with an extraction solvent to provide an extraction mixture; sonicating the extraction mixture; separating the sonicated mixture into an extracted Pongamia composition and an extract that comprises karanjin or pongamol, or both; and measuring the concentration of karanjin or pongamol, or both, present in the extract. In some variations, the extraction solvent comprises alkyl ketone. In some embodiments, the measuring step involves determining the concentration of karanjin and/or pongamol by high performance liquid chromatography with an ultraviolet detector (e.g., using a HPLC-DAD).

In one aspect, provided is a Pongamia oil composition, having: less than or equal to about 1000 ppm of karanjin and pongamol combined as determined by HPLC-DAD analysis of an acetone extract obtained from the Pongamia oil composition; less than or equal to about 1% by weight of unsaponifiable matter; a peroxide value of less than or equal to about 5 meq/kg; a p-anisidine value of less than or equal to about 10; and less than or equal to about 5000 ppm of residual solvent, wherein residual solvent, if present, is food grade solvent. In some variations, the Pongamia oil composition has less than or equal to about 150 ppm of karanjin as determined by HPLC-DAD analysis of an acetone extract obtained from the Pongamia oil composition; less than or equal to about 150 ppm of pongamol as determined by HPLC-DAD analysis of an acetone extract obtained from the Pongamia oil composition; less than or equal to about 1% by weight of unsaponifiable matter; a peroxide value of less than or equal to about 5 meq/kg; a p-anisidine value of less than or equal to about 5; and less than or equal to about 5000 ppm of residual solvent, wherein residual solvent, if present, is food grade solvent.

In another aspect, provided is a method for producing a Pongamia oil composition, comprising: mechanically separating dehulled Pongamia oilseeds to produce crude Pongamia oil and a seedcake that is at least partially deoiled, wherein the crude Pongamia oil comprises Pongamia oil, karanjin, pongamol, other furanoflavonoids, and other unsaponifiable matter; and extracting the crude Pongamia oil with ethanol at an elevated temperature to produce the Pongamia oil composition, wherein the ratio of solvent to crude Pongamia oil is between 1:1 and 20:1, and wherein the composition is edible and non-bitter tasting, has less than or equal to about 1000 ppm of karanjin and pongamol combined as determined by HPLC-DAD analysis of an acetone extract obtained from the Pongamia oil composition; less than or equal to about 1% by weight of unsaponifiable matter; a peroxide value of less than or equal to about 5 meq/kg; and a p-anisidine value of less than or equal to about 10.

In yet another aspect, provided is a continuous countercurrent method for producing a Pongamia oil composition, comprising: a) mechanically separating dehulled Pongamia oilseeds to produce crude Pongamia oil and a seedcake that is at least partially deoiled, wherein the crude Pongamia oil comprises Pongamia oil, karanjin, pongamol, other furanoflavonoids, and other unsaponifiable matter; b) separating the crude Pongamia oil into a raffinate and a solvent-rich light phase by liquid-liquid extraction using immiscible solvent at an elevated temperature, wherein the ratio of solvent to crude Pongamia oil is between 1:1 and 20:1, wherein the raffinate comprises Pongamia oil and residual solvent, wherein the solvent comprises ethanol, and wherein the solvent-rich light phase comprises solvent and residual Pongamia oil; c) cooling the raffinate to separate the residual solvent from Pongamia oil; d) isolating at least a portion of the Pongamia oil in the cooled raffinate to produce the Pongamia oil composition, wherein the composition is edible and non-bitter tasting, has less than or equal to about 1000 ppm of karanjin and pongamol combined as determined by HPLC-DAD analysis of an acetone extract obtained from the Pongamia oil composition; less than or equal to about 1% by weight of unsaponifiable matter; a peroxide value of less than or equal to about 5 meq/kg; and a p-anisidine value of less than or equal to about 10; e) separating at least a portion of the solvent from the solvent-rich light phase; and f) combining the isolated solvent with additional crude Pongamia oil for liquid-liquid extraction.

In other aspects, provided herein are food or beverage products comprising the Pongamia oil compositions obtainable by the methods provided herein. In some embodiments, the Pongamia oil composition is light yellow as determined by the Lovibond Color—AOCS Scale; the composition comprises less than or equal to about 200 ppm karanjin and pongamol combined as determined by HPLC-DAD analysis of an acetone extract obtained from the Pongamia oil composition, and the composition has a neutral flavor. In other embodiments, the Pongamia oil composition is yellow as determined by the Lovibond Color—AOCS Scale; the composition comprises less than or equal to about 150 ppm karanjin and less than or equal to about 150 ppm pongamol as determined by HPLC-DAD analysis of an acetone extract obtained from the Pongamia oil composition; and the composition has one or more sensory attributes selected from the group consisting of: nuttiness, butteriness, grassiness, smoothness, and sweetness, and any combinations thereof.

### DESCRIPTION OF THE FIGURES

The present application can be understood by reference to the following description taken in conjunction with the accompanying figures.

FIG. 1 depicts an exemplary analytical method to determine concentrations of karanjin and/or pongamol in a Pongamia oil sample.

FIG. 2 depicts an exemplary batch process to purify a crude Pongamia oil mixture to produce a Pongamia oil composition that is edible and non-bitter tasting.

FIGS. 3A and 3B compare furanoflavonoids present in crude Pongamia oil (FIG. 3A) versus those absent in an exemplary purified Pongamia oil composition (FIG. 3B), as determined by HPLC.

FIG. 4 depicts an exemplary continuous system to purify a crude Pongamia oil mixture to produce a Pongamia oil composition that is edible and non-bitter tasting.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

In some aspects, provided herein are Pongamia oil compositions, and methods of producing such compositions. In some variations, the Pongamia oil compositions pass human taste testing. In certain variations, the Pongamia oil compositions are edible and non-bitter tasting. The methods provided to produce the edible Pongamia oil removes or decreases the amount of furanoflavonoids and other unsaponifiable matter present, including removing or decreasing the amount of karanjin and/or pongamol, which are typically considered inedible and potentially harmful to humans. Additionally, the Pongamia oil compositions provided have various properties that make such compositions suitable for use in food and beverage products. For example, in certain variations, the Pongamia oil compositions have low insoluble impurities, low soap content, high smoke point, low mono- and di-glycerides, low glycerol, fewer unidentified fatty acids, low total sterols, and light color (including, for example, low chlorophyll content).

### Pongamia Oil Compositions

In some embodiments, the Pongamia oil compositions provided herein are edible, non-bitter, and have an overall acceptable sensory profile in humans (e.g., with respect to taste and smell).

Unsaponifiable Matter

Unsaponifiable matter present in Pongamia compositions generally include compounds other than the fatty acids. For example, unsaponifiable matter may include furanoflavonols, chlorophylls, tocopherols and sterols. In some embodiments, the Pongamia oil compositions provided herein (including produced according to the methods herein) have a lower unsaponifiable matter content, as compared to the crude Pongamia oil from which the compositions are obtained. In some embodiments, the Pongamia oil compositions provided herein (including produced according to the methods herein) have a low unsaponifiable matter content. In some variations, the Pongamia oil compositions provided herein (including produced according to the methods herein) have less than or equal to 5%, less than or equal to 4%, less than or equal to 3%, less than or equal to 2%, less than or equal to 1%, or less than or equal to 0.5% by weight of unsaponifiable matter in oil. In some variations, the Pongamia oil compositions provided herein (including produced according to the methods herein) have at least 50%, at least 55%, at least 60%, at least 70%, at least 80%, or at least 90% by weight less unsaponifiable matter content as compared to the crude Pongamia oil from which the composition was obtained. Any suitable methods or techniques known in the art may be used to measure unsaponifiable matter content in the compositions herein. In some variations, the unsaponifiable matter content is determined by AOCS Ca 6a-40.

As noted above, furanoflavonols are one type of unsaponifiable matter. Furanoflavonoids are a class of compounds that are typically present in Pongamia oilseeds, and includes anti-nutritional compounds such as karanjin and pongamol. In some embodiments, provided are Pongamia oil compositions having a low, negligible or non-detectable furanoflavonoids content. In some variations, the Pongamia oil compositions have less than or equal to about 1000 ppm, less than or equal to about 750 ppm, less than or equal to about 500 ppm, less than or equal to about 300 ppm, less than or equal to about 250 ppm, or less than or equal to about 200 ppm of furanoflavonoids. In some variations, the Pongamia oil compositions have less than or equal to 500 ppm, less than or equal to 450 ppm, less than or equal to 400 ppm, less than or equal to 350 ppm, less than or equal to 300 ppm, less than or equal to 250 ppm, less than or equal to 200 ppm, less than or equal to 150 ppm, less than or equal to 100 ppm, less than or equal to 50 ppm, less than or equal to 40 ppm, less than or equal to 30 ppm, less than or equal to 20 ppm, or less than or equal to 10 ppm of furanoflavonoids.

In some embodiments, the Pongamia oil compositions have less than or equal to 150 ppm of karanjin and/or pongamol. In some variations of the foregoing, the karanjin and pongamol concentrations are determined by the solvent extraction analytical methods described herein.

In some embodiments, the karanjin and pongamol contents of the Pongamia oil composition are determined by HPLC analysis of an alkyl ketone extract obtained from the Pongamia oil composition. In still other embodiments, the karanjin and pongamol contents of the Pongamia oil composition are determined by HPLC analysis of an alkyl ketone extract obtained from the Pongamia oil composition according the to the analytical method described herein. In some embodiments, the alkyl ketone is acetone. In certain embodiments, the HPLC analysis of the alkyl ketone extract further comprises mass spectrometry detection or ultraviolet detection. In still certain other embodiments, the karanjin and pongamol contents of the Pongamia oil composition are determined by HPLC-DAD analysis of an acetone extract obtained from the Pongamia oil composition according the to the analytical method described herein.

In some variations, the Pongamia oil compositions have less than or equal to 500 ppm, less than or equal to 400 ppm, less than or equal to 300 ppm, less than or equal to 250 ppm, less than or equal to 200 ppm, less than or equal to 150 ppm, less than or equal to 140 ppm, less than or equal to 130 ppm, less than or equal to 120 ppm, less than or equal to 110 ppm, less than or equal to 100 ppm, less than or equal to 90 ppm, less than or equal to 80 ppm, less than or equal to 70 ppm, less than or equal to 60 ppm, less than or equal to 50 ppm, less than or equal to 40 ppm, less than or equal to 30 ppm, less than or equal to 20 ppm, or less than or equal to 10 ppm of karanjin.

In some variations, the Pongamia oil compositions have less than or equal to 500 ppm, less than or equal to 400 ppm, less than or equal to 300 ppm, less than or equal to 250 ppm, less than or equal to 200 ppm, less than or equal to 150 ppm, less than or equal to 140 ppm, less than or equal to 130 ppm, less than or equal to 120 ppm, less than or equal to 110 ppm, less than or equal to 100 ppm, less than or equal to 90 ppm, less than or equal to 80 ppm, less than or equal to 70 ppm, less than or equal to 60 ppm, less than or equal to 50 ppm, less than or equal to 40 ppm, less than or equal to 30 ppm, less than or equal to 20 ppm, or less than or equal to 10 ppm of pongamol.

In other variations, the Pongamia oil compositions may be characterized in terms of their combined karanjin and pongamol concentrations. For example, in some variations, the Pongamia oil compositions have less than or equal to about 1000 ppm, less than or equal to about 750 ppm, less than or equal to about 500 ppm, less than or equal to about 300 ppm, less than or equal to about 250 ppm, or less than or equal to about 200 ppm karanjin and pongamol combined. In certain variations, the Pongamia oil compositions have less than or equal to 150 ppm, less than or equal to 140 ppm, less than or equal to 130 ppm, less than or equal to 120 ppm, less than or equal to 110 ppm, less than or equal to 100 ppm, less than or equal to 90 ppm, less than or equal to 80 ppm, less than or equal to 70 ppm, less than or equal to 60 ppm, less than or equal to 50 ppm, less than or equal to 40 ppm, less than or equal to 30 ppm, less than or equal to 20 ppm, or less than or equal to 10 ppm of karanjin and pongamol.

In still other variations, the Pongamia oil compositions have a ratio of karanjin to pongamol of greater than or equal to about 1. In other variations, the Pongamia oil compositions have a ratio of karanjin to pongamol of less than or equal to about 1.

In one variation, the Pongamia oil compositions has a non-detectable amount of karanjin and/or pongamol, based on the solvent extraction analytical methods described herein.

In other variations, the Pongamia oil compositions produced according to the methods described herein (e.g., obtained from crude Pongamia oil) have less than 100 times, less than 500 times, or less than 1000 times the amount of karanjin as compared to the crude Pongamia oil from which the compositions were obtained. In some embodiments, the Pongamia oil compositions produced according to the methods described herein (e.g., obtained from crude Pongamia oil) have less than 100 times, less than 150 times, or less than 200 times the amount of pongamol as compared to the crude Pongamia oil from which the compositions were obtained.

Fatty Acids

In some embodiments, the Pongamia oil compositions described herein have lower amounts of mono- and di-glycerides, low glycerol, and/or fewer unidentified fatty acids as compared to the crude Pongamia oil from which the Pongamia oil compositions are obtained (e.g., according to the methods described herein). The Pongamia oil compositions have certain fatty acid profiles.

In some embodiments, the amount of total identified fatty acids in the Pongamia composition is at least 90%; or between 80% and 99%, or between 85% and 95%.

The Pongamia oil compositions have a combination of various monounsaturated, polyunsaturated and/or saturated fatty acids. In some variations, the Pongamia compositions have a greater monounsaturated fatty acid content than polyunsaturated fatty acids. In some variations, the Pongamia compositions have a greater saturated fatty acid content than polyunsaturated fatty acids. In some variations, the Pongamia compositions have a greater monounsaturated fatty acid content than saturated fatty acids.

In certain embodiments, the Pongamia compositions have a low trans fatty acids content, or a lower trans fatty acids content as compared to the crude Pongamia oil from which the Pongamia oil compositions are obtained (e.g., according to the methods described herein). In some variations, the amount of trans fatty acids in the Pongamia compositions is less than or equal to 5%, less than or equal to 1%, less than or equal to 0.5%, or less than or equal to 0.25%.

In some embodiments, the methods provided herein do not change the healthful fatty acid profile, except in a positive way (for example, increasing oleic acid content on a % weight basis). This is generally in contrast to other methods known in the art that methods can radically change the fatty acid profile in an adverse way (for example, lower yield, less healthful or functional balance of fatty acids). In certain embodiments, the Pongamia oil compositions comprise Omega 6 fatty acids, or Omega 9 fatty acids, or any combination thereof. In certain embodiments, the Pongamia oil compositions comprise Omega 3 fatty acids, Omega 6 fatty acids, Omega 7 fatty acids, or Omega 9 fatty acids, or any combination thereof. In some variations, the amount of Omega 9 fatty acids is greater than Omega 6 fatty acids. In certain variations, the amount of Omega 6 fatty acids and Omega 9 fatty acids combined is greater than the amount of Omega 3 fatty acids and Omega 7 fatty acids combined. In some variations, the amount of Omega 6 fatty acids and Omega 9 fatty acids combined is at least 50%, or at least 60%; or between 15% and 80%, or between 20% and 75%. In certain variations, the amount of Omega 3 fatty acids and/or Omega 7 fatty acids is less than 5%, less than 4%, less than 3%, less than 2%, or less than 1%.

In certain embodiments, the Pongamia oil compositions comprise myristic acid, palmitic acid, palmitoleic acid, margaric acid, heptadecenoic acid, stearic acid, vaccenic acid, oleic acid, linoleic acid, arachidic acid, gondoic acid, eicosadienoic acid, behenic acid, erucic acid, or lignoceric acid, or any isomers thereof, or any combination of the foregoing.

In still further embodiments, the Pongamia oil compositions may be described in terms of the amount of individual fatty acids present in the composition as a percentage of the total fatty acids present.

In some variations, the Pongamia oil compositions comprise oleic acid. In one variation, the amount of oleic acid in the Pongamia oil compositions is at least 40%, or at least 50%; or between 30% and 70%, between 30% and 60%, or between 45% and 55%.

In certain variations, the Pongamia oil compositions comprise linoleic acid, or isomers thereof. In one variation, the amount of linoleic acid, or isomers thereof, in the Pongamia oil compositions is at least 15%; or between 10% and 20%. In certain variations, the Pongamia oil compositions comprise linolenic acid, or isomers thereof. In certain variations, the linolenic acid is alpha linolenic acid. In one variation, the amount of alpha linolenic acid in the Pongamia oil compositions is between 1% and 5%.

In certain variations, the Pongamia oil compositions comprise palmitic acid. In one variation, the amount of palmitic acid in the Pongamia oil compositions is at least 5%; or between 5% and 10%.

In certain variations, the Pongamia oil compositions comprise stearic acid. In one variation, the amount of stearic acid in the Pongamia oil compositions is at least 5%; or between 5% and 10%.

In certain variations, the Pongamia oil compositions comprise behenic acid. In one variation, the amount of behenic acid in the Pongamia oil compositions is between 1% and 10%, or between 1% and 5%.

In certain variations, the Pongamia oil compositions comprise arachidic acid, gondoic acid, or lignoceric acid, or any combination thereof. In one variation, the amount of arachidic acid, gondoic acid, or lignoceric acid in the Pongamia oil compositions is independently between 1% and 5%.

In certain variations, the Pongamia oil compositions comprise erucic acid. In one variation, the amount of erucic acid is at least 0.06%.

Any suitable methods or techniques known in the art may be used to measure fatty acid content in the compositions herein. For example, in some variations, the test method used is AOAC 996.06.

Tocopherols

In some embodiments, the Pongamia oil compositions comprise tocopherol. In some variations, the tocopherol is alpha-tocopherol, beta-tocopherol, delta-tocopherol, gamma-tocopherol, or any combination thereof. In certain embodiments, the Pongamia oil compositions have a total tocopherol content of less than or equal to 250 ppm, less than or equal to 300 ppm, less than or equal to 400 ppm; or between 100 ppm and 400 ppm.

In some variations, the alpha-tocopherol content is the highest of the four aforementioned tocopherols. In certain variations, the content of alpha-tocopherol and gamma-tocopherol combined is greater than the content of beta-tocopherol and delta-tocopherol combined.

In one embodiment, the Pongamia oil compositions have an alpha-tocopherol content of less than or equal to 200 ppm, less than or equal to 250 ppm or less than or equal to 300 ppm; or between 200 ppm and 500 ppm, between 200 ppm and 400 ppm, between 200 ppm and 350 ppm, or between 200 ppm and 300 ppm.

In another embodiment, the Pongamia oil compositions have a gamma-tocopherol content of less than or equal to 100 ppm or less than or equal to 150 ppm; or between 100 and 200 ppm.

Any suitable methods or techniques known in the art may be used to measure tocopherol content in the compositions herein. For example, in some variations, the test method used is AOAC 971.30 with HPLC.

Sterols

In some embodiments, the Pongamia oil compositions comprise sterols. In some variations, the Pongamia oil compositions described herein have lower amounts of sterols as compared to the crude Pongamia oil from which the Pongamia oil compositions are obtained (e.g., according to the methods described herein).

In some variations, the sterol is 24-methylene-cholesterol, beta-sitosterol, brassicasterol, campestanol, cholesterol, clerosterol, delta-5,23-stigmastadienol, delta-5,24-stigmastadienol, delta-5-avenasterol, delta-7-avenasterol, delta-7-campesterol, delta-7-stigmastenol, sitostanol, or stigmasterol, or any combination thereof. In certain embodiments, the Pongamia oil compositions have a total sterol content of less than or equal to 2500 ppm, less than or equal to 2000 ppm, less than or equal to 1500 ppm, less than or equal to 1000 ppm, less than or equal to 750 ppm, less than or equal to 500 ppm, or less than or equal to 100 ppm.

In some variations, the Pongamia oil compositions further comprise beta-sitosterol. In certain variations of the foregoing, the Pongamia oil compositions further comprise campestanol, stigmasterol, or delta-5-avenasterol, or any combination thereof. In yet other variations of the foregoing, the Pongamia oil compositions further comprise clerosterol, delta-5,24-stigmastadienol, or sitostanol, or any combination thereof.

Any suitable methods or techniques known in the art may be used to measure sterol content in the compositions herein. For example, in some variations, the test method used is COI/T.20/Doc No.10.

Residual Solvent

The methods for producing Pongamia oil compositions as provided herein may result in the presence of residual solvent content in the Pongamia oil compositions. Low levels of residual solvent in such Pongamia oil compositions may be desirable as the presence of residual solvent can may influence the sensory profile of the Pongamia oil composition. In some variations, the Pongamia oil compositions produced the methods herein may be subjected to processing techniques to remove residual solvent from, or to de-solventize, the Pongamia oil composition in order to achieve the residual solvent levels as described herein.

In some embodiments, the Pongamia oil composition comprises residual solvent. In certain embodiments, the Pongamia oil composition comprises residual solvent, wherein the residual solvent, if present, comprises food-grade solvent. In certain embodiments, the Pongamia oil composition comprises residual solvent, wherein the residual solvent, if present, is food-grade solvent. In certain embodiments, the residual solvent is ethanol. In still further embodiments, the Pongamia oil composition comprises residual ethanol.

In some variations, the Pongamia oil composition has less than or equal to about 5000 ppm, less than or equal to about 4000 ppm, less than or equal to about 3000 ppm, less than or equal to about 2000 ppm, less than or equal to about 1000 ppm, or less than or equal to about 500 ppm of residual solvent. In some variations, the Pongamia oil composition has less than or equal to 5000 ppm, less than or equal to about 4000 ppm, less than or equal to about 3000 ppm, less than or equal to about 2000 ppm, less than or equal to about 1000 ppm, or less than or equal to about 500 ppm of residual solvent, wherein the residual solvent, if present, is food grade solvent. In some embodiments, the residual solvent comprises ethanol. In certain variations, the Pongamia oil composition has less than or equal to about 5000 ppm, less than or equal to about 4000 ppm, less than or equal to about 3000 ppm, less than or equal to about 2000 ppm, less than or equal to about 1000 ppm, or less than or equal to about 500 ppm of residual ethanol. Any suitable methods or techniques known in the art may be used to measure residual solvent content in the compositions herein. In some variations, the residual solvent is determined by AOCS Cg 4-94.

Peroxide and p-Anisidine Values

In some variations, the Pongamia oil compositions may be further characterized by the level of oxidation products present in the oil. When exposed to oxygen and/or heat, fats and oils may undergo oxidation reactions, which cause the oils to develop an undesirable rancid flavor. As detailed above, the methods of the present disclosure for producing Pongamia oil compositions provides means to remove or decrease the amount of furanoflavonoids and other unsaponifiable matter present. Existing methods for the removal of these components often utilize harsh conditions, such as highly caustic reagents and extreme temperatures (e.g., reflux).

In contrast, the methods provided herein employ gentler temperature and solvent conditions to treat crude Pongamia oil to remove furanoflavonoids and other unsaponifiable matter. As a result, the Pongamia oil compositions obtained herein exhibit low furanoflavonoid content and low unsaponifiable matter content as well as minimal oxidation.

The extent of oxidation can be characterized by the presence and concentration of primary oxidation products that may form during initial oxidation and the secondary oxidation products that may form during the breakdown of the primary oxidation products with more extensive oxidation. The degree of primary oxidation may be assessed by measuring the peroxide value (in milliequivalents/kg), which an index used to quantify the amount of hydroxperoxides present in the oil. The extent of secondary oxidation may be assessed by measuring the p-anisidine value. Both the peroxide value and p-anisidine value are taken together to provide a complete representation of oxidation in the oil.

In some variations, the Pongamia oil composition has a peroxide value of less than or equal to about 5 meq/kg, less than or equal to about 4 meq/kg, less than or equal to about 3 meq/kg, less than or equal to about 2 meq/kg, or less than or equal to about 1 meq/kg. In certain variations, the Pongamia oil composition has a peroxide value of less than or equal to about 5 meq/kg. Any suitable methods or techniques known in the art may be used to measure peroxide value in the compositions herein. In some variations, the peroxide value is determined by AOCS test method AOCS Cd 8-53.

In other variations, the Pongamia oil composition has a p-anisidine value of less than or equal to about 15, less than or equal to about 12, less than or equal to about 10, less than or equal to about 7, less than or equal to about 5, less than or equal to about 4, less than or equal to about 3, or less than or equal to about 2. In certain variations, the Pongamia oil composition has a p-anisidine value of less than or equal to about 10. In certain other variations, the Pongamia oil composition has a p-anisidine value of less than or equal to about 5. Any suitable methods or techniques known in the art may be used to measure p-anisidine in the compositions herein. In some variations, the p-anisidine value is determined by AOCS test method AOCS Cd 18-90.

Thermal and Physical Properties

The Pongamia oil compositions provided herein may be further characterized by their thermal and physical properties. The array of applications and uses that are available to different fats and oil is largely determined by the thermal and physical behavior of the fats or oils under certain temperature conditions for the specific use. The thermal and physical behavior of the fats and oils are, in turn, largely influenced by the fatty acid profile of the fats and oils. As described above, the methods provided herein for producing Pongamia oil compositions having reduced concentrations of karanjin, pongamol, and other unsaponifiable matter are contrasted by other methods in the art, which may affect the fatty acid content and profile of the resulting oil in an adverse way (for example, lower yield, less healthful or functional balance of fatty acids).

The thermal and physical properties of the Pongamia oil compositions provided herein reflect the non-destructive methods for removing furanoflavonoids and other unsaponifiable matter used to obtain the compositions.

In some variations, the Pongamia oil compositions of the present disclosure may be characterized by their physical state at a given temperature, or their temperature-dependent behavior, such as a melting profile. In some variations, the Pongamia oil compositions are liquid at a temperature of greater than or equal to about 10° C. In some variations, the Pongamia oil composition is liquid at room temperature. In other variations, the Pongamia oil compositions are semi-solid at a temperature of about 0-10° C. In some variations, the melting profile is determined by differential scanning calorimetry (DSC).

In still other embodiments, the Pongamia oil compositions of the present disclosure may be characterized by their solid-fat content at a given temperature. For example, in some embodiments, the composition has a solid fat content of between about 1% and about 10% at a temperature of about 0° C., about 2° C., about 5° C., or about 10° C. In certain variations, the composition has a solid fat content of between about 1% and about 10% at a temperature of about 5° C. Any suitable methods or techniques known in the art may be used to measure solid fat content in the compositions herein. In some variations, the solid-fat content is determined by AOCS test method AOCS-Cd 16b-93.

In other embodiments, the Pongamia oil composition may be characterized by its dropping point. The dropping point is the upper temperature at which a fat or grease can retain semi-solid structure. Above the dropping point, the fat or grease converts to a liquid state. In some embodiments, the Pongamia oil composition has a dropping point of less than or equal to about 20° C., less than or equal to about 15° C. or less than or equal to about 10° C. In certain embodiments, the Pongamia oil composition has a dropping point of less than or equal to about 10° C. Any suitable methods or techniques known in the art may be used to measure dropping point in the compositions herein. In some variations, the dropping point is determined by AOCS test method AOCS Cc 18-80.

In some embodiments, the Pongamia oil composition may be characterized by its flash point. The flash point is the lowest temperature at which the vapors of a substance may ignite, when in the presence of an ignition source. In some embodiments, the Pongamia oil composition has a flash point of at least about 200° C., at least about 220° C. or at least about 240° C. Any suitable methods or techniques known in the art may be used to measure flash point in the compositions herein. In some variations, the flash point is determined by AOCS test method AOCS Cc 9b-55.

In some embodiments, the Pongamia oil composition may be characterized by its smoke point. The smoke point of an oil is the temperature at which an oil begins to generate continuous, visible smoke under defined conditions. Oils having higher smoke points may find enhanced utility in food-related applications, such as in pan frying or sautéing, deep frying or baking, where high temperatures are common. In still other embodiments, the Pongamia oil composition has a smoke point of at least about 180° C., at least about 190° C., at least about 195° C., at least about 200° C., or at least about 210° C. In still other embodiments, the Pongamia oil composition has a higher smoke point than the crude Pongamia oil from which it is obtained. Any suitable methods or techniques known in the art may be used to measure smoke point in the compositions herein. In some variations, the smoke point is determined by AOCS test method AOCS Cc 9a-48.

In other variations, the Pongamia oil compositions provided herein may be characterized by their viscosities. The viscosity of a liquid, such as an oil, is a measure of the liquid's resistance to flow and/or deform. In some embodiments, the Pongamia oil composition has viscosity of at least about 30 centipoise, at least about 40 centipoise, or at least about 50 centipoise as determined at about 25° C. In other embodiments, the Pongamia oil composition has viscosity of less than or equal to 600 centipoise, less than or equal to 500 centipoise, less than or equal to 250 centipoise, less than or equal to 100 centipoise, less than or equal to 90 centipoise, less than or equal to 80 centipoise, less than or equal to about 70 centipoise, or less than or equal to about 60 centipoise as determined at about 25° C. In certain embodiments, the Pongamia oil composition has a viscosity of between about 30 centipoise and about 600 centipoise at about 25° C. In still other embodiments, the Pongamia oil composition has a lower viscosity than the crude Pongamia oil from which it is obtained as measured at the same temperature.

Other Properties

In some embodiments, the Pongamia oil compositions have one or more of the following properties selected from:

(i) a free fatty acid content of less than or equal to about 1%;

(ii) less than or equal to about 0.1% of insoluble impurities;

(iii) less than or equal to about 25 ppm of phosphorus;

(iv) less than or equal to about 0.1 ppm of chlorophyll;

(v) less than or equal to about 5000 ppm of residual solvents;

(vi) a moisture content of less than or equal to about 1%;

(vii) less than or equal to about 1% glycerol;

(viii) less than or equal to about 2% monoglycerides;

(ix) less than or equal to about 5% diglycerides; and

(x) at least about 90% triglycerides.

In some embodiments, the free fatty acid content is determined by AOCS test method AOCS Ca 5a-40. In some embodiments, the insoluble impurities content is determined by AOCS test method AOCS Ca 3a-46. In some embodiments, the phosphorus content is determined by AOCS Ca 20-99, mod. In some embodiments, the chlorophyll content is determined by AOCS Ch 4-91. In some embodiments, the moisture content is determined by AOCS Ca 2b-38. In some embodiments, the glycerol content is determined by AOCS Cd 11c-93. In some embodiments, the monoglyceride content is determined by AOCS Cd 11c-93. In some embodiments, the diglyceride content is determined by AOCS Cd 11c-93. In some embodiments, the triglyceride content is determined by AOCS Cd 11c-93.

In certain embodiments, the Pongamia oil compositions have a lower unsaponifiable matter content as compared to the crude Pongamia oil from which the composition was obtained (e.g., according to the methods described herein).

In addition to their compositional content, the Pongamia oil compositions of the present disclosure may also be described in terms of their physical properties including but not limited to color and/or turbidity.

In certain embodiments, the Pongamia oil compositions provided herein (e.g., produced according to the methods described herein) have a lighter color as compared to the crude Pongamia oil from which the compositions are obtained. In certain variations, the final color of the Pongamia oil composition is lighter than the initial color of the crude Pongamia oil. In one variation, the crude Pongamia oil is red and/or brown (e.g., including red, brown, reddish brown or brownish red), and the Pongamia oil compositions obtained thereof (e.g., according to the methods described herein) is yellow and/or white (e.g., including yellow, light yellow, white, or off white). In certain variations, color of the same is determined using the Lovibond Color—AOCS Scale. In certain embodiments, the color is determined using the Lovibond Color-AOCS scale using a 1-inch or 5.25-inch cell path. Thus, in one variation, the crude Pongamia oil has a Lovibond color of 1.8R, 70Y; and the Pongamia oil compositions obtained thereof (e.g., according to the methods described herein) has a Lovibond color of 1.4R, 38Y, according to the Lovibond Color—AOCS Scale (AOCS method Cc 13b-45) using a 5.25-inch cell path.

In some variations, the Pongamia oil compositions have a Lovibond color, wherein the Y-value is less than 25, as determined by the Lovibond Color—AOCS Scale (AOCS method Cc 13b-45) using a 1-inch cell path. In certain variations wherein the Y-value is less than 25, as determined by the Lovibond Color—AOCS Scale (AOCS method Cc 13b-45) using a 1-inch cell path, the Pongamia oil composition is light yellow. In other embodiments, have a Lovibond color, wherein the Y-value is greater than or equal to 25, as determined by the Lovibond Color—AOCS Scale (AOCS method Cc 13b-45) using a 1-inch cell path. In certain other variations wherein the he Y-value is greater than or equal to 25, as determined by the Lovibond Color—AOCS Scale (AOCS method Cc 13b-45) using a 1-inch cell path, the Pongamia oil composition is yellow.

In addition to the color of the Pongamia oil compositions, the Pongamia oil compositions may be characterized by their haziness or turbidity by methods known in the art. In still other variations, the Pongamia oil compositions provided in the present disclosure have reduced turbidity as compared to the crude Pongamia oil from which the compositions are obtained.

Any suitable methods known in the art to measure or determine the properties above may be employed.

### Sensory Characteristic Profile

As detailed above, the Pongamia oil compositions of the present disclosure, for which the furanoflavonoid and other unsaponifiable matter content has been reduced, are edible, non-bitter, and have an overall acceptable sensory profile in humans (e.g., with respect to taste and smell).

In still other variations, the Pongamia oil compositions of the present disclosure may be characterized by the presence or absence of one or more sensory attributes including but not limited to Pongamia flavor/notes, nuttiness, butteriness, grassiness, smoothness, sweetness, oiliness, astringency, sharpness, bitterness, and sourness. In some variations, the Pongamia oil compositions have one or more sensory attributes selected from the group consisting of: Pongamia flavor/notes, nuttiness, butteriness, grassiness, smoothness, sweetness, oiliness, astringency, sharpness, bitterness, and sourness, and any combinations thereof.

In some variations, the Pongamia oil compositions may be characterized by the presence of one or more sensory characteristics selected from the group consisting of Pongamia flavor/notes, nuttiness, butteriness, grassiness, smoothness, sweetness, and oiliness.

In still other variations, the Pongamia oil compositions may be characterized by the absence of one or more sensory characteristics selected from the group consisting of astringency, sharpness, bitterness, and sourness.

In yet other variations, the Pongamia oil compositions may be characterized by the mildness of sensory attributes. For example, in some variations, the Pongamia oil compositions may be characterized as having a non-bitter taste, neutral flavor, blandness, clean flavor, or absence of aftertaste, or any combinations thereof.

In one aspect, provided herein is a Pongamia oil composition having:

(i) less than or equal to about 1000 ppm of karanjin and pongamol combined, e.g., as determined by HPLC-DAD analysis of an acetone extract obtained from the Pongamia oil composition;
(ii) less than or equal to about 1% by weight of unsaponifiable matter, e.g., as determined by AOCS Ca 6a-40;
(ii) a peroxide value of less than or equal to about 5 meq/kg, e.g., as determined by AOCS Cd 8-53:
(iv) a p-anisidine value of less than or equal to about 10, e.g., as determined by AOCS Cd 18-90;
(v) less than or equal to about 5000 ppm of residual solvent, e.g., as determined by AOCS Cg 4-94, wherein residual solvent, if present, is food grade solvent;
(vi) at least 40% oleic acid present out of the total fatty acids, e.g., as determined by AOAC 996.06;
(vii) light yellow or yellow color, e.g., as determined by the Lovibond Color—AOCS Scale;
(viii) a neutral flavor, or one or more sensory attributes selected from the group consisting of: nuttiness, butteriness, grassiness, smoothness, and sweetness, and any combinations thereof; or
(ix) any combinations of (i)-(viii) thereof.

In some embodiments of the present aspect, the Pongamia oil composition has less than or equal to about 1000 ppm of karanjin and pongamol combined as determined by HPLC-DAD analysis of an acetone extract obtained from the Pongamia oil composition;

less than or equal to about 1% by weight of unsaponifiable matter, e.g., as determined by AOCS Ca 6a-40;
a peroxide value of less than or equal to about 5 meq/kg, e.g., as determined by AOCS Cd 8-53:
a p-anisidine value of less than or equal to about 10, e.g., as determined by AOCS Cd 18-90; and
less than or equal to about 5000 ppm of residual solvent, e.g., as determined by AOCS Cg 4-94, wherein residual solvent, if present, is food grade solvent.

In other embodiments of the present aspect, the Pongamia oil composition has less than or equal to about 1000 ppm of karanjin and pongamol combined as determined by HPLC-DAD analysis of an acetone extract obtained from the Pongamia oil composition;

less than or equal to about 1% by weight of unsaponifiable matter, e.g., as determined by AOCS Ca 6a-40;
a peroxide value of less than or equal to about 5 meq/kg, e.g., as determined by AOCS Cd 8-53;
a p-anisidine value of less than or equal to about 10, e.g., as determined by AOCS Cd 18-90; and
at least 40% oleic acid present out of the total fatty acids, e.g., as determined by AOAC 996.06.

In still other embodiments, the Pongamia oil composition has:

(i) less than or equal to about 1000 ppm of karanjin and pongamol combined, e.g., as determined by HPLC-DAD analysis of an acetone extract obtained from the Pongamia oil composition;
(ii) less than or equal to about 1% by weight of unsaponifiable matter, e.g., as determined by AOCS Ca 6a-40;
(ii) a peroxide value of less than or equal to about 5 meq/kg, e.g., as determined by AOCS Cd 8-53;
(iv) a p-anisidine value of less than or equal to about 10, e.g., as determined by AOCS Cd 18-90;
(v) less than or equal to about 5000 ppm of residual solvent, e.g., as determined by AOCS Cg 4-94, wherein residual solvent, if present, is food grade solvent;
(vi) at least 40% oleic acid present out of the total fatty acids, e.g., as determined by AOAC 996.06;
(vii) light yellow or yellow color, e.g., as determined by the Lovibond Color—AOCS Scale; and
(viii) a neutral flavor, or one or more sensory attributes selected from the group consisting of: nuttiness, butteriness, grassiness, smoothness, and sweetness, and any combinations thereof.

In some embodiments, the Pongamia oil composition has a light yellow color as determined by the Lovibond Color—AOCS Scale and a neutral flavor. In other embodiments, the Pongamia oil composition has a yellow color as determined by the Lovibond Color—AOCS Scale and one or more sensory attributes selected from the group consisting of: nuttiness, butteriness, grassiness, smoothness, and sweetness, and any combinations thereof. In some embodiments, which may be combined with any of the foregoing embodiments, the Pongamia oil composition is light yellow as determined by the Lovibond Color—AOCS Scale and the composition has less than or equal to about 200 ppm of karanjin and pongamol combined as determined by HPLC-DAD analysis of an acetone extract obtained from the Pongamia oil composition.

In other embodiments, the Pongamia oil composition.
(i) is liquid at room temperature;
(ii) has a viscosity of between about 30 centipoise and 600 centipoise, e.g., as determined at 25° C.;
(iii) has a solid fat content of between about 1% and about 10% at a temperature of about 5° C., e.g., as determined by AOCS-Cd 16b-93;
(iv) has a smoke point of at least about 195° C., e.g., as determined by AOCS Cc 9a-48; or
(v) has a flash point of at least about 200° C., e.g., as determined by AOCS Cc 9b-55;
   or any combinations of (i)-(v) thereof.

### Methods of Analyzing Pongamia Oil Compositions

The high concentrations of karanjin and pongamol present in the oil and seedcakes obtained from Pongamia oilseeds have generally prevented the use of the oil and seedcake in food products due to the lack of edibility due to adverse taste and smell, as well as potential toxicity. These compounds can render the oil and seedcake inedible and potentially harmful to humans and animals. Prior attempts to develop edible Pongamia compositions have been unsuccessful in part due to the fact that consistent acceptable maximum thresholds for karanjin concentrations and other anti-nutrients for consumption have not yet been established. Moreover, existing methods for analyzing Pongamia compositions have been inaccurate and unreliable such that assessing karanjin concentrations in Pongamia compositions, let alone the further determining maximum acceptable karanjin concentrations, is a formidable endeavor. Thus, there remains a need for more accurate methods for determining the levels of karanjin and other anti-nutritional compounds present in Pongamia compositions.

The present disclosure addresses this need by providing methods of analyzing Pongamia oil compositions, namely methods of determining concentrations of karanjin and other chemical compounds intrinsic to Pongamia oilseeds, with greater accuracy and precision than existing methods. Thus, in some aspects, provided herein are methods for analyzing the karanjin and/or pongamol concentrations in Pongamia oil using a solvent extraction analytical method.

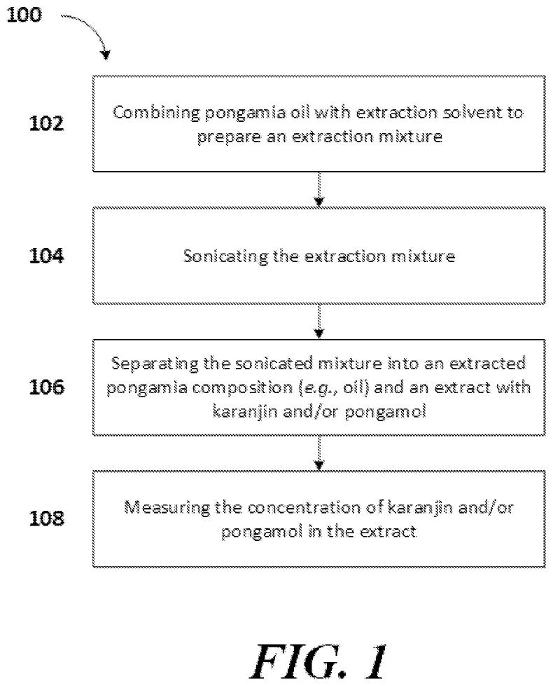

With reference to FIG. 1, provided is an exemplary process 100 to analyze a Pongamia oil sample. In step 102, an extraction mixture is provided by combining Pongamia oil with an extraction solvent. In some embodiments, the extraction solvent comprises alkyl ketone. In certain variations, the extraction solvent comprises methyl ketone. In one variation, the extraction solvent comprises acetone.

With reference again to FIG. 1, in steps 104 and 106, the extraction mixture is sonicated and then separated into an extracted Pongamia composition (e.g., oil) and an extract that has karanjin and/or pongamol.

In step 108, the concentration of karanjin and/or pongamol present in the extract is then measured. In some variations, the concentration of karanjin and/or pongamol is determined by high performance liquid chromatography with an ultraviolet detector (UV). In one variation, the ultraviolet detector is a diode array detector (i.e., HPLC-DAD is employed).

In some aspects, provided is an analytical method, comprising: combining Pongamia oil with an extraction solvent to provide an extraction mixture, wherein the extraction solvent comprises alkyl ketone, and wherein the Pongamia oil comprises karanjin or pongamol, or both; sonicating the extraction mixture to produce a sonicated mixture; separating the sonicated mixture into an extracted Pongamia composition and an alkyl ketone extract, wherein the extract comprises karanjin or pongamol, or both; and measuring the concentration of karanjin or pongamol, or both, present in the extract. In one variation, the alkyl ketone is acetone. In some embodiments of the foregoing, the measuring step comprises determining the concentration of karanjin or pongamol, or both, by high performance liquid chromatography with an ultraviolet detector. In one variation, the ultraviolet detector is a diode array detector.

In certain aspects, the analytical methods provided herein to detect the concentration of karanjin and pongamol are an improvement over analytical methods generally known in the art, including for example methods that involve the use of HPLC with detection by mass spectrometry (MS) and methods that were generally directed to analyzing a Pongamia meal sample. The analytical methods provided herein allow for accurate determination of a Pongamia oil sample, by using a particular sample preparation and HPLC with detection by UV (e.g., HPLC-DAD) as opposed to HPLC with detection by mass spectrometry (e.g., HPLC-MS-MS).

### Methods of Producing Pongamia Oil Compositions

In some aspects, provided herein are methods of obtaining an edible Pongamia oil from a crude Pongamia oil is obtained from plant material derived from a Pongamia tree or plant (also known as “Cytisus pinnatus”, “Dalbergia arborea”, “Derris indica”, “Galedupa pungum”, “karanj”, “Millettia pinnata”, “pongam”, “Pongamia”, “Pongamia glabra”, “Pterocarpus flavus”, “Pongamia pinnata”, and “Robinia mitis”, “Indian beech”, and “mempari”). In some variations, the crude Pongamia oil is obtained from Pongamia oilseeds.

In some aspects, provided is a method for producing a Pongamia oil composition, comprising: mechanically separating dehulled Pongamia oilseeds to produce crude Pongamia oil and a seedcake that is at least partially deoiled; and extracting the crude Pongamia oil with an immiscible solvent at an elevated temperature to produce the Pongamia oil composition. In some embodiments, the crude Pongamia oil comprises Pongamia oil, karanjin, pongamol, other furanoflavonoids, and other unsaponifiable matter. In some embodiments, the compositions obtained is edible and non-bitter tasting, has less than 150 ppm of karanjin and/or pongamol, and has less than 1% of unsaponifiable matter.

Any suitable methods, techniques or reactor systems may be employed for the batch liquid-liquid extraction.

Batch Process

In some embodiments, the methods for producing a Pongamia oil composition is performed as a batch process. Crude Pongamia oil may be obtained by mechanically separating dehulled Pongamia oilseeds. The crude Pongamia oil obtained comprises Pongamia oil, karanjin, pongamol, other furanoflavonoids, and other unsaponifiable matter. Then, the crude Pongamia oil is combined with an immiscible solvent at an elevated temperature to form a mixture. In some variations, the elevated temperature is less than the boiling point of the immiscible solvent. In some variations, the mixture is agitated (e.g., stirred) for a suitable period of time. For example, in one variation, the mixture is agitated for at least 5 minutes, at least 10 minutes, at least 15 minutes, at least 30 minutes, at least 45 minutes, or at least 60 minutes; or between 5 minutes and 2 hours, between 5 minutes and 1 hour, between 15 minutes and 45 minutes.

While at the elevated temperature, the mixture is allowed to settle into at least a Pongamia oil layer and a solvent layer (e.g., made up of the immiscible solvent as described herein). The solvent layer is removed at the elevated temperature, and the Pongamia oil layer is cooled. The cooled layer is also allowed to further settle into a Pongamia oil layer and a solvent layer. The solvent layer is removed, and the Pongamia oil layer is combined with fresh immiscible solvent at an elevated temperature to form a mixture. The mixture may be agitated at the elevated temperature for a suitable period of time, and then is allowed to settle and decant at the elevated temperature, followed by cooling, settling and decanting to obtain a Pongamia oil layer that can be further combined with fresh immiscible solvent at an elevated temperature. Such steps are repeated to ultimately obtain the edible and non-bitter tasting Pongamia oil compositions described herein from the last Pongamia oil layer that is isolated.

In certain aspects, provided is a method for producing a Pongamia oil composition, comprising: mechanically separating dehulled Pongamia oilseeds to produce crude Pongamia oil and a seedcake that is at least partially deoiled; combining the crude Pongamia oil with an immiscible solvent at an elevated temperature to form a mixture; allowing the mixture to settle, at the elevated temperature, into at least a Pongamia oil layer and a solvent layer; and removing the solvent layer, at the elevated temperature, to isolate the Pongamia oil layer. In some variations, the combining of the crude Pongamia oil with the immiscible solvent includes agitation.

In some embodiments, provided is a method for producing a Pongamia oil composition, comprising: mechanically separating dehulled Pongamia oilseeds to produce crude Pongamia oil and a seedcake that is at least partially deoiled; combining the crude Pongamia oil with an immiscible solvent at an elevated temperature to form a mixture; allowing the mixture to settle, at the elevated temperature, into at least a Pongamia oil layer and a solvent layer; removing the solvent layer, at the elevated temperature, to isolate the Pongamia oil layer; cooling the Pongamia oil layer; allowing the cooled layer to settle into at least a Pongamia oil layer and a solvent layer; and removing the solvent layer to isolate the Pongamia oil layer.

The Pongamia oil layer comprises the edible and non-bitter tasting Pongamia oil compositions described herein.

Any suitable methods, techniques or reactor systems may be employed for the batch liquid-liquid extraction. In some embodiments, the batch liquid-liquid extraction is performed in a static reactor, such as a static cone bottom tank. In other embodiments, the batch liquid-liquid extraction is performed in a reactor configured for agitation, including vibration, sonication, and/or mechanical agitation. For example, in one variation, the batch liquid-liquid extraction is performed using a forced agitation reactor. In some variations, the forced agitation reactor comprises tray(s), impeller(s), and/or propellers. In certain variations wherein forced agitation reactor comprises one or more impellers, the one or more impellers is a homogenizer, a paddle, a turbine, a screw, a ribbon blade, an anchor blade, a stirrer, or a scraper.

Continuous Process

In some embodiments, the methods for producing a Pongamia oil composition are performed as a continuous process. In some variations, the methods are performed as a continuous countercurrent process.

Crude Pongamia oil is obtained by mechanically separating dehulled Pongamia oilseeds. The crude Pongamia oil obtained comprises Pongamia oil, karanjin, pongamol, other furanoflavonoids, and other unsaponifiable matter. Then, a continuous liquid-liquid extraction is performed. The crude Pongamia oil is separated into a raffinate and a solvent-rich light phase using an immiscible solvent at an elevated temperature. The raffinate comprises Pongamia oil and residual solvent, whereas the solvent-rich light phase comprises solvent and residual Pongamia oil.

Any suitable methods, techniques or reactor systems may be employed for the continuous liquid-liquid extraction. In some embodiments, the continuous liquid-liquid extraction is performed configured in a reactor for agitation, including vibration, sonication, and/or mechanical agitation. For example, in one variation, the continuous liquid-liquid extraction is performed using a forced agitation reactor. In some variations, the forced agitation reactor comprises tray(s), impeller(s), and/or propellers. In certain variations wherein forced agitation reactor comprises one or more impellers, the one or more impellers is a homogenizer, a paddle, a turbine, a screw, a ribbon blade, an anchor blade, a stirrer, or a scraper. In certain variations, the forced agitation reactor is a forced agitated trayed column. The raffinate exits the column at the bottom, and the solvent-rich light phase exits the column at the top. The raffinate is cooled to separate the residual solvent from the Pongamia oil. In some variations, all of the residual solvent is separated from the Pongamia oil. The Pongamia oil is isolated to obtain the Pongamia oil compositions described herein.

Elevated Temperature for Batch and Continuous Extraction

In some variations, the elevated temperature is greater than or equal to about 25° C., greater than or equal to about 30° C., greater than or equal to about 35° C., greater than or equal to about 40° C., greater than or equal to about 45° C., greater than or equal to about 50° C., greater than or equal to about 55° C., greater than or equal to about 60° C., greater than or equal to about 65° C., or greater than or equal to about 70° C. In other variations, the elevated temperature is less than or equal to about 75° C., less than or equal to about 70° C., less than or equal to about 65° C., less than or equal to about 60° C., less than or equal to about 55° C., less than or equal to about 50° C., less than or equal to about 45° C., less than or equal to about 40° C., or less than or equal to about 35° C. In some embodiments, the elevated temperature is between about 30° C. and about 75° C., between about 30° C. and about 70° C., between about 30° C. and about 65° C., between about 30° C. and about 60° C., between about 30° C. and about 55° C., between about 30° C. and about 50° C., between about 30° C. and about 45° C., between about 30° C. and about 40° C., between about 30° C. and about 35° C., between about 35° C. and about 75° C., between about 35° C. and about 70° C., between about 35° C. and about 65° C., between about 35° C. and about 60° C., between about 35° C. and about 55° C., between about 35° C. and about 50° C., between about 35° C. and about 45° C., between about 35° C. and about 40° C., between about 40° C. and about 75° C., between about 40° C. and about 70° C., between about 40° C. and about 65° C., between about 40° C. and about 60° C., between about 40° C. and about 55° C., between about 40° C. and about 50° C., between about 40° C. and about 45° C., between about 45° C. and about 75° C., between about 45° C. and about 70° C., between about 45° C. and about 65° C., between about 45° C. and about 60° C., between about 45° C. and about 55° C., between about 45° C. and about 50° C., between about 50° C. and about 75° C., between about 50° C. and about 70° C., between about 50° C. and about 65° C., between about 50° C. and about 60° C., between about 50° C. and about 55° C., between about 55° C. and about 75° C., between about 55° C. and about 70° C., between about 55° C. and about 65° C., between about 55° C. and about 60° C., between about 60° C. and about 75° C., between about 60° C. and about 70° C., between about 60° C. and about 65° C., between about 65° C. and about 75° C., between about 65° C. and about 70° C., or between about 70° C. and about 75° C.

In some variations, the elevated temperature is less than the boiling point of the immiscible solvent. For example, in certain variations wherein the immiscible solvent comprises ethanol, the elevated temperature is less than about 78° C. at atmospheric pressure.

It should be understood that, in other exemplary embodiments, the process may include added or omitted steps. For example, in one embodiment, the solvent separated from the Pongamia oil can be condensed, and stripped (e.g., to remove any accumulated water). In some variations, the foregoing may be performed in a stripping column or a distillation column. In another embodiment, the residual Pongamia oil in the solvent-rich light phase is isolated and distilled to produce additional Pongamia oil composition.

Immiscible Solvent

In some embodiments, the solvent used is immiscible with the crude Pongamia oil. In some variations, the solvent comprises alcohol. In certain variations, the solvent comprises at least about 60%, at least about 70%, at least about 80%, least about 90%, at least about 92%, at least about 95%, or at least about 990% alcohol. In certain variations, the solvent comprises C₁₋₂₀ alcohol, a C₁₋₁₀ alcohol, or a C₁₋₅ alcohol. In one variation, the solvent comprises ethanol. In certain variations, the solvent comprises at least about 90% ethanol or at least about 95% ethanol.

In some variations, the ratio of solvent to crude Pongamia oil is less than or equal to about 20:1, less than or equal to about 15:1, less than or equal to about 10:1, or less than or equal to about 5:1. In other variations, the ratio of solvent to crude Pongamia oil is greater than or equal to about 1:1 or greater than or equal to about 5:1. In some variations, the ratio of solvent to crude Pongamia oil is between about 1:1 and about 20:1, between about 1:1 and about 15:1, between about 1:1 and about 10:1, or between about 1:1 and about 5:1.

Crude Pongamia Oil

In some embodiments, the crude Pongamia oil comprises Pongamia oil, karanjin, pongamol, other furanoflavonoids, and other unsaponifiable matter.

In certain embodiments, the crude Pongamia oil has at least 500 ppm, at least 10,000, or at least 30,000 ppm; or between 10,000 ppm and 30,000 ppm of unsaponifiable matter.

In certain embodiments, the crude Pongamia oil has at least 500 ppm, at least 10,000, or at least 30,000 ppm; or between 10,000 ppm and 30,000 ppm of furanoflavonoids. In certain embodiments, the crude Pongamia oil has at least 10,000 ppm of karanjin and/or a pongamol. In some variations of the foregoing, the karanjin and pongamol concentrations are determined by the solvent extraction analytical methods described herein.

In some variations, the crude Pongamia oil has at least 500 ppm, at least 10,000, or at least 30,000 ppm; or between 10,000 ppm and 30,000 ppm of karanjin. In other variations, the crude Pongamia oil has at least 500 ppm, at least 10,000, or at least 30,000 ppm; or between 10,000 ppm and 30,000 ppm of pongamol. In other variations, the crude Pongamia oil has at least 500 ppm, at least 10,000, or at least 30,000 ppm; or between 10,000 ppm and 30,000 ppm of karanjin and pongamol combined.

The crude Pongamia oil used for the methods described herein may be produced from various methods and techniques known in the art or obtained from any commercially available sources. In some variations, the crude Pongamia oil is obtained by mechanically separating Pongamia oilseeds. In one variation, the crude Pongamia oil is obtained by cold-pressing Pongamia oilseeds.

Optionally, the Pongamia oilseeds may be dehulled to obtain the crude Pongamia oil. Thus, in some variations, the crude Pongamia oil is obtained by dehulling Pongamia oilseeds to produce dehulled oilseeds; and mechanically separating the dehulled oilseeds to produce the crude Pongamia oil and a seedcake that is at least partially deoiled. In other variations, the crude Pongamia oil is obtained by heating Pongamia oilseeds at a temperature between 25° C. and 200° C. for a suitable time to provide treated oilseeds; dehulling the treated oilseeds to produce dehulled oilseeds; and mechanically separating the dehulled oilseeds to produce the crude Pongamia oil and a deoiled seedcake.

Dehulling typically involves passing Pongamia beans through a dehuller to loosen the hulls and the bean, and separating the two fractions. Any suitable techniques known in the art may be employed to achieve dulling and hull separation. For example, in some variations, dehulling is performed by passing the Pongamia beans through an impact type dehuller and loosening the hulls from beans. Other types of dehulling equipment such as abrasive/brushing type may be used for this purpose. Separation of the beans from the hulls can be performed by, for example, a gravity table or an aspirator.

The beans are then mechanically pressed (e.g., cold-pressed), which typically may be performed using an expeller to remove free oil and produce reduced fat (e.g., 10-14% fat) Pongamia meal. Cold-pressing can be performed using any suitable techniques known in the art. For example, cold-pressing can be performed using various pieces of equipment, such as a Farmet FL-200 expeller press. In some variations, pressing can include passing the dehulled beans through the apparatus to produce free oil and reduced fat meal. The partially defatted mechanically pressed beans can remove approximately 60-75% of the original Pongamia oil content.

### Food and Beverage Products

In certain aspects, provided are also food and beverage products incorporating or produced using the Pongamia oil compositions herein. Such Pongamia oil compositions may be used as salad oil, frying oil, sauteeing oil, vinaigrettes, sauces, dressings, fats in meat mimetics, beverages, or blended margarines and other solid fat applications.

The Pongamia oil compositions as provided herein have a number of favorable compositional properties, including low concentrations of karanjin, pongamol, and unsaponifiable matter, low peroxide values, low p-anisidine values, low residual solvent content, and high oleic acid content, that make the Pongamia oil compositions suited for use in food applications. In addition to these compositional attributes, the Pongamia oil compositions of the present disclosure also possess various organoleptic and functional properties that can be selected for various applications in which fats and/or oils are desired.

In some embodiments, provided herein are food and beverage products comprising a Pongamia oil composition, wherein the Pongamia oil composition has a light yellow color as determined by the Lovibond Color—AOCS Scale and a neutral flavor. In other embodiments, the Pongamia oil composition has a yellow color as determined by the Lovibond Color—AOCS Scale and one or more sensory attributes selected from the group consisting of: nuttiness, butteriness, grassiness, smoothness, and sweetness, and any combinations thereof. In some embodiments, which may be combined with any of the foregoing embodiments, the Pongamia oil composition is light yellow as determined by the Lovibond Color—AOCS Scale and the composition has less than or equal to about 200 ppm of karanjin and pongamol combined as determined by HPLC-DAD analysis of an acetone extract obtained from the Pongamia oil composition.

In other embodiments, the food or beverage product comprises a Pongamia oil composition, wherein the Pongamia oil composition:

(i) has light yellow or yellow color as determined by the Lovibond Color—AOCS Scale; and
(ii) has a neutral flavor, or one or more sensory attributes selected from the group consisting of: nuttiness, butteriness, grassiness, smoothness, and sweetness, and any combinations thereof.
(iii) is liquid at room temperature;
(iv) has a viscosity of between about 30 centipoise and 600 centipoise as determined at 25° C.;
(v) has a solid fat content of between about 1% and about 10% at a temperature of about 5° C. as determined by AOCS-Cd 16b-93;
(vi) has a smoke point of at least about 195° C. as determined by AOCS Cc 9a-48; or
(vii) has a flash point of at least about 200° C. as determined by AOCS Cc 9b-55;
or any combinations of (i)-(vii) thereof.

The food and beverages products can include various other components other than the Pongamia oil compositions described herein. For example, the food and beverage products may include, for example, water, other fats and oils, sweeteners (such as sugar), salt, thickeners (such as pectin and other hydro colloids), anti-foaming agents, natural and artificial flavorings, preservatives, and coloring agents.

In another aspect, provided is a method of preparing food and/or beverages products. Such methods may include one or more of mixing/blending, pasteurizing and/or sterilizing, and packaging.

### ENUMERATED EMBODIMENTS

The following enumerated embodiments are representative of some aspects of the invention.
1. A method for producing a Pongamia oil composition, comprising:

mechanically separating dehulled Pongamia oilseeds to produce crude Pongamia oil and a seedcake that is at least partially deoiled, wherein the crude Pongamia oil comprises Pongamia oil, karanjin, pongamol, other furanoflavonoids, and other unsaponifiable matter; and

extracting the crude Pongamia oil with an immiscible solvent at an elevated temperature to produce the Pongamia oil composition, wherein the ratio of solvent to crude Pongamia oil is between 1:1 and 20:1, and wherein the composition is edible and non-bitter tasting, has less than 150 ppm of karanjin and/or pongamol, and has less than 1% of unsaponifiable matter.
2. A method for producing a Pongamia oil composition, comprising:

a) mechanically separating dehulled Pongamia oilseeds to produce crude Pongamia oil and a seedcake that is at least partially deoiled, wherein the crude Pongamia oil comprises Pongamia oil, karanjin, pongamol, other furanoflavonoids, and other unsaponifiable matter;

b) combining the crude Pongamia oil with an immiscible solvent at an elevated temperature to form a mixture;

c) allowing the mixture to settle, at the elevated temperature, into at least a Pongamia oil layer and a solvent layer;

d) removing the solvent layer from step c), at the elevated temperature, to isolate the Pongamia oil layer, wherein the Pongamia oil layer comprises edible and non-bitter tasting Pongamia oil.
3. The method of embodiment 2, further comprising: repeating steps c) and d) at a second elevated temperature that is lower than the elevated temperature in steps c) and d), or optionally the second elevated temperature is about 5 to 10 degrees Celsius below the boiling point of the solvent.
4. The method of embodiment 2, further comprising:

cooling the Pongamia oil layer from step c);

allowing the Pongamia oil layer to settle into at least a Pongamia layer and a solvent layer; and

removing the solvent layer to isolate the Pongamia oil layer, wherein the Pongamia oil layer comprises edible and non-bitter tasting Pongamia oil.
5. The method of any one of embodiments 2 to 4, further comprising repeating steps b)-d) by combining the isolated Pongamia oil layer with fresh immiscible solvent.
6. The method of any one of embodiments 2 to 4, further comprising:

e) combining the composition in step d) with fresh immiscible solvent at the elevated temperature to form a second mixture;

f) allowing the second mixture to settle, at the elevated temperature, into at least a Pongamia oil layer and a solvent layer; and

g) removing the solvent layer from step f), at the elevated temperature, to isolate the Pongamia oil layer, wherein the Pongamia oil layer comprises edible and non-bitter tasting Pongamia oil.
7. The method of any one of embodiments 2 to 4, further comprising:

e) combining the composition in step d) with fresh immiscible solvent at the elevated temperature to form a second mixture;

f) allowing the second mixture to settle, at the elevated temperature, into at least a Pongamia oil layer and a solvent layer;

g) removing the solvent layer from step f), at the elevated temperature, to isolate the Pongamia oil layer;

h) cooling the Pongamia oil layer from step g);

i) allowing the cooled layer from step h) to settle into at least a Pongamia oil layer and a solvent layer; and

j) removing the solvent layer from step i) to isolate the Pongamia oil layer, wherein the Pongamia oil layer comprises edible and non-bitter tasting Pongamia oil.
8. The method of any one of embodiments 2 to 7, wherein the combining of the crude Pongamia oil with the immiscible solvent comprises agitating the mixture.
9. A continuous countercurrent method for producing a Pongamia oil composition, comprising:

a) mechanically separating dehulled Pongamia oilseeds to produce crude Pongamia oil and a seedcake that is at least partially deoiled,
wherein the crude Pongamia oil comprises Pongamia oil, karanjin, pongamol, other furanoflavonoids, and other unsaponifiable matter;

b) separating the crude Pongamia oil into a raffinate and a solvent-rich light phase by liquid-liquid extraction using an immiscible solvent at an elevated temperature,
wherein the ratio of solvent to crude Pongamia oil is between 1:1 and 20:1,
wherein the raffinate comprises Pongamia oil and residual solvent, and
wherein the solvent-rich light phase comprises solvent and residual Pongamia oil;

c) cooling the raffinate to separate the residual solvent from Pongamia oil;

d) isolating at least a portion of the Pongamia oil in the cooled raffinate to produce the Pongamia oil composition,
wherein the composition is edible and non-bitter tasting, has less than or equal to 150 ppm of karanjin and/or pongamol, and has less than 1% of unsaponifiable matter;

e) separating at least a portion of the solvent from the solvent-rich light phase; and

f) combining the isolated solvent with additional crude Pongamia oil for liquid-liquid extraction.
10. The method of embodiment 9, wherein the continuous liquid-liquid extraction is performed using a forced agitation trayed column.
11. The method of embodiment 10, wherein the raffinate exits the column at the bottom, and the solvent-rich light phase exits the column at the top.
12. The method of any one of embodiments 1 to 11, wherein the elevated temperature is less than the boiling point of the immiscible solvent.
13. The method of any one of embodiments 9 to 12, wherein at least a portion of the solvent separated from the solvent-rich light phase is performed in an evaporator.
14. The method of embodiment 13, wherein the solvent is evaporated from the residual Pongamia oil under vacuum.
15. The method of embodiment 14, further comprising condensing the solvent, and stripping the solvent of any accumulated water in a stripping column.
16. The method of any one of embodiments 9 to 15, further comprising isolating the residual Pongamia oil in the solvent-rich light phase; and distilling solvent from the isolated residual Pongamia oil to produce additional Pongamia oil composition.
17. The method of any one of embodiments 1 to 16, wherein the immiscible solvent comprises alcohol.
18. The method of any one of embodiments 1 to 16, wherein the immiscible solvent comprises ethanol.
19. The method of any one of embodiments 1 to 18, wherein the immiscible solvent comprises at least about 60% alcohol.
20. The method of any one of embodiments 1 to 19, wherein the composition has a lower unsaponifiable matter content than the crude Pongamia oil.
21. The method of any one of embodiments 1 to 20, wherein the composition has a lower furanoflavonoids content than the crude Pongamia oil.
22. The method of any one of embodiments (xi) to 21, wherein the composition has less than or equal to 150 ppm of furanoflavonoids.
23. The method of any one of embodiments (xi) to 22, wherein the furanoflavonoids comprise karanjin, or pongamol, or both.
24. The method of embodiment 23, wherein the composition has less than or equal to 150 ppm of karanjin and/or pongamol.
25. The method of any one of embodiments (xi) to 24, wherein the crude Pongamia oil has an initial color, and the Pongamia oil composition produced has a final color, wherein the final color of the Pongamia oil composition is lighter than the initial color of the crude Pongamia oil.
26. The method of embodiment 25, wherein the initial color is red and/or brown, and the final color is yellow.
27. The method of any one of embodiments (xi) to 26, wherein the crude Pongamia oil is mechanically separated Pongamia oil.
28. A Pongamia oil composition produced according to the method of any one of the preceding embodiments.
29. A Pongamia oil composition having less than 150 ppm of karanjin and/or pongamol and less than 1% of unsaponifiable matter, wherein the composition is edible and non-bitter tasting.
30. The composition of embodiment 29, wherein the composition further comprises other furanoflavonoids.
31. The composition of embodiment 29, wherein the composition has less than or equal to 150 ppm of furanoflavonoids.
32. The composition of embodiment 31, wherein the concentration of karanjin or pongamol, or both, is determined by the method of any one of embodiments 1 to 4.
33. The composition of any one of embodiments 29 to 32, wherein the composition is obtained from a crude Pongamia oil, and the composition has a color that is lighter than the color of the crude Pongamia oil.
34. The composition of embodiment 33, wherein the color of the composition is yellow.
35. The composition of any one of embodiments 29 to 34, further comprising solvent.
36. The composition of embodiment 35, wherein the solvent is present at a concentration of less than 5000 ppm.
37. The composition of any one of embodiments 29 to 36, wherein the composition comprises fatty acids.
38. The composition of embodiment 37, wherein the fatty acids are monounsaturated fatty acids, polyunsaturated fatty acids, saturated fatty acids, trans fatty acids, Omega 3 fatty acids, Omega 6 fatty acids, Omega 7 fatty acids, or Omega 9 fatty acids, or any combination thereof.
39. The composition of any one of embodiments 29 to 36, wherein the composition comprises oleic acid, linoleic acid, palmitic acid, stearic acid, behenic acid, alpha linolenic acid, lignoceric acid, arachidic acid, gondoic acid, oleic acid, vaccenic acid, palmitoleic acid, eicosadienoic acid, linoleic acid, margaric acid, gondoic acid, erucic acid, palmitoleic acid, heptadecenoic acid, or myristic acid, or any isomers thereof, or any combination of the foregoing.
40. The composition of any one of embodiments 29 to 39, wherein the composition has:
   (xi) a free fatty acid content of less than or equal to 1%;
   (xii) less than or equal to 0.1% of insoluble impurities;
   (xiii) less than or equal to 25 ppm of phosphorus;
   (xiv) less than or equal to 0.1 ppm of chlorophyll;
   (xv) less than or equal to 5000 ppm of residual solvents;
   (xvi) a moisture content of less than or equal to 1%;
   (xvii) less than or equal to 1% glycerol;
   (xviii) less than or equal to 2% monoglycerides;
   (xix) less than or equal to 5% diglycerides; or
   (xx) at least 90% triglycerides,
      or any combination of (i)-(x).
41. The composition of any one of embodiments 29 to 41, wherein the composition has a lower unsaponifiable matter content as compared to the crude Pongamia oil from which the composition was obtained.
42. The composition of embodiment 41, wherein the composition has at least 50% less unsaponifiable matter content as compared to the crude Pongamia oil from which the composition was obtained.
43. The composition of any one of embodiments 29 to 42, wherein the composition further comprises tocopherols.
44. The composition of embodiment 43, wherein the tocopherols comprise alpha-tocopherol, beta-tocopherol, delta-tocopherol, or gamma-tocopherol, or any combination thereof
45. The composition of embodiment 29 or 44, wherein the composition has less than or equal to 400 ppm of tocopherols.
46. The composition of any one of embodiments 43 to 45, wherein the composition has less than or equal to 200 ppm of alpha-tocopherol.
47. The composition of any one of embodiments 29 to 46, wherein the composition further comprises sterols.
48. The composition of embodiment 47, wherein the sterols comprise beta-sitosterol, campesterol, cholesterol, clerosterol, delta-5,24-stigmastadienol, delta-5-avenasterol, sitostanol, or stigmasterol, or any combination thereof.
49. The composition of embodiment 47 or 48, wherein the composition has less than 2500 ppm of sterols.
50. Use of the Pongamia oil composition of any one of embodiments 29 to 49 as salad oil, frying oil, sauteeing oil, vinaigrettes, sauces, dressings, fats in meat mimetics, beverages, or blended margarines and other solid fat applications, or any combination thereof.
51. A food or beverage product, comprising the Pongamia oil composition of any one of embodiments 29 to 49.
52. The product of embodiment 51, wherein the product is salad oil, frying oil, sauteeing oil, vinaigrettes, sauces, dressings, fats in meat mimetics, beverages, or blended margarines and other solid fat applications.
53. An analytical method, comprising:
   combining Pongamia oil with an extraction solvent to provide an extraction mixture, wherein the extraction solvent comprises alkyl ketone, and wherein the Pongamia oil comprises karanjin or pongamol, or both;
   sonicating the extraction mixture to produce a sonicated mixture;
   separating the sonicated mixture into an extracted Pongamia composition and an alkyl ketone extract, wherein the extract comprises karanjin or pongamol, or both; and measuring the concentration of karanjin or pongamol, or both, present in the extract.
54. The method of embodiment 53, wherein the alkyl ketone is acetone.
55. The method of embodiment 53 or 54, wherein the measuring step comprises determining the concentration of karanjin or pongamol, or both, by high performance liquid chromatography with an ultraviolet detector.
56. The method of embodiment 55, wherein the ultraviolet detector is a diode array detector.
57. A Pongamia oil composition, having:
   less than or equal to about 1000 ppm of karanjin and pongamol combined as determined by HPLC-DAD analysis of an acetone extract obtained from the Pongamia oil composition;
   less than or equal to about 1% by weight of unsaponifiable matter as determined by AOCS Ca 6a-40;
   a peroxide value of less than or equal to about 5 meq/kg as determined by AOCS Cd 8-53;
   a p-anisidine value of less than or equal to about 10 as determined by AOCS Cd 18-90, and
   less than or equal to about 5000 ppm of residual solvent as determined by AOCS Cg 4-94, wherein residual solvent, if present, is food grade solvent.
58. The composition of embodiment 57, having:
   less than or equal to about 150 ppm of karanjin as determined by HPLC-DAD analysis of an acetone extract obtained from the Pongamia oil composition;
   less than or equal to about 150 ppm of pongamol as determined by HPLC-DAD analysis of an acetone extract obtained from the Pongamia oil composition;
   less than or equal to about 1% by weight of unsaponifiable matter as determined by AOCS Ca 6a-40;
   a peroxide value of less than or equal to about 5 meq/kg as determined by AOCS Cd 8-53;
   a p-anisidine value of less than or equal to about 5 as determined by AOCS Cd 18-90; and
   less than or equal to about 5000 ppm of residual solvent as determined by AOCS Cg 4-94, wherein residual solvent, if present, is food grade solvent.
59. The composition of embodiment 57 or 58, wherein the composition comprises less than or equal to about 1000 ppm of residual solvent.
60. The composition of any one of embodiments 57 to 59, wherein the residual solvent comprises ethanol.
61. The composition of any one of embodiments 57 to 60, wherein the composition is liquid at room temperature.
62. The composition of any one of embodiments 57 to 61, wherein the composition has a viscosity of between about 30 centipoise and 600 centipoise as determined at 25° C.
63. The composition of any one of embodiments 57 to 62, wherein the composition has a solid fat content of between about 1% and about 10% at a temperature of about 5° C. as determined by AOCS-Cd 16b-93.
64. The composition of any one of embodiments 57 to 63, wherein the composition has a smoke point of at least about 195° C. as determined by AOCS Cc 9a-48.
65. The composition of any one of embodiments 57 to 64, wherein the composition has less than or equal to about 400 ppm of tocopherols as determined by AOAC 971.30 with HPLC.
66. The composition of any one of embodiments 57 to 65, wherein the composition wherein the composition has less than 2500 ppm of sterols as determined by COI/T.20/Doc No.10.
67. The composition of any one of embodiments 57 to 66, wherein the composition comprises oleic acid, linoleic acid, palmitic acid, stearic acid, behenic acid, alpha linolenic acid, lignoceric acid, arachidic acid, gondoic acid, oleic acid, vaccenic acid, palmitoleic acid, eicosadienoic acid, linoleic acid, margaric acid, gondoic acid, erucic acid, palmitoleic acid, heptadecenoic acid, or myristic acid, or any isomers thereof, or any combination of the foregoing, as determined by AOAC 996.06.
68. The composition of embodiment 67, wherein the composition comprises at least 40% oleic acid as determined by AOAC 996.06.
69. The composition of any one of embodiments 57 to 68, wherein the color of the composition is yellow or light yellow as determined by the Lovibond Color—AOCS Scale using a 1-inch cell path, wherein:
   when the composition is yellow, the composition has a Lovibond Color Y-value of greater than or equal to 25; and
   when the composition is light yellow, the composition has a Lovibond Color Y-value of less than 25.
70. The composition of any one of embodiments 57 to 69, wherein the composition has one or more sensory attributes selected from the group consisting of: nuttiness, butteriness, grassiness, smoothness, and sweetness, and any combinations thereof.
71. The composition of any one of embodiments 57 to 70, wherein the composition has a ratio of karanjin to pongamol of greater than about 1.
72. The composition of any one of embodiments 57 to 69, wherein the color of the composition is light yellow and the composition has a Lovibond Color Y-value of less than 25 as determined by the Lovibond Color—AOCS Scale using a 1-inch cell path.
73. The composition of any one of embodiments 57 to 69 and 72, wherein the color of the composition is light yellow, and wherein the composition comprises less than or equal to about 200 ppm karanjin and pongamol combined.
74. The composition of any one of embodiments 57 to 69, 72 and 73, wherein the composition has a neutral flavor.
75. The composition of any one of embodiments 57 to 69 and 72 to 74, wherein the composition has a ratio of karanjin to pongamol of less than or equal to 1.
76. The composition of any one of embodiments 57 to 75, wherein the composition has:
   (i) a free fatty acid content of less than or equal to about 1% as determined by AOCS Ca 5a-40;
   (ii) less than or equal to about 0.1% of insoluble impurities as determined by AOCS Ca 3a-46;
   (iii) less than or equal to about 25 ppm of phosphorus as determined by AOCS Ca 20-99, mod.;
   (iv) less than or equal to about 0.1 ppm of chlorophyll as determined by AOCS Ch 4-91;
   (v) a moisture content of less than or equal to about 1% as determined by AOCS Ca 2b-38;
   (vi) less than or equal to about 1% glycerol as determined by AOCS Cd 11c-93;
   (vii) less than or equal to about 2% monoglycerides as determined by AOCS Cd 11c-93;
   (viii) less than or equal to about 5% diglycerides as determined by AOCS Cd 11c-93; and
   (ix) at least about 90% triglycerides as determined by AOCS Cd 11c-93,
   (x) or any combination of (i)-(ix).
77. A method for producing a Pongamia oil composition, comprising:
   mechanically separating dehulled Pongamia oilseeds to produce crude Pongamia oil and a seedcake that is at least partially deoiled, wherein the crude Pongamia oil comprises Pongamia oil, karanjin, pongamol, other furanoflavonoids, and other unsaponifiable matter; and
   extracting the crude Pongamia oil with ethanol at an elevated temperature to produce the Pongamia oil composition, wherein the ratio of solvent to crude Pongamia oil is between 1:1 and 20:1, and wherein the composition is edible and non-bitter tasting, has less than or equal to about 1000 ppm of karanjin and pongamol combined as determined by HPLC-DAD analysis of an acetone extract obtained from the Pongamia oil composition; less than or equal to about 1% by weight of unsaponifiable matter as determined by AOCS Ca 6a-40; a peroxide value of less than or equal to about 5 meq/kg as determined by AOCS Cd 8-53; and a p-anisidine value of less than or equal to about 10 as determined by AOCS Cd 18-90.
78. The method of embodiment 77, wherein the crude Pongamia oil and the immiscible solvent form a mixture and the mixture is agitated for at least about 30 minutes.
79. A continuous countercurrent method for producing a Pongamia oil composition, comprising:
   a) mechanically separating dehulled Pongamia oilseeds to produce crude Pongamia oil and a seedcake that is at least partially deoiled, wherein the crude Pongamia oil comprises Pongamia oil, karanjin, pongamol, other furanoflavonoids, and other unsaponifiable matter;
   b) separating the crude Pongamia oil into a raffinate and a solvent-rich light phase by liquid-liquid extraction using immiscible solvent at an elevated temperature,
   wherein the ratio of solvent to crude Pongamia oil is between 1:1 and 20:1,
   wherein the raffinate comprises Pongamia oil and residual solvent,
   wherein the solvent comprises ethanol, and
   wherein the solvent-rich light phase comprises solvent and residual Pongamia oil:
   c) cooling the raffinate to separate the residual solvent from Pongamia oil;
   d) isolating at least a portion of the Pongamia oil in the cooled raffinate to produce the Pongamia oil composition,
   wherein the composition is edible and non-bitter tasting, has less than or equal to about 1000 ppm of karanjin and pongamol combined as determined by HPLC-DAD analysis of an acetone extract obtained from the Pongamia oil composition; less than or equal to about 1% by weight of unsaponifiable matter as determined by AOCS Ca 6a-40; a peroxide value of less than or equal to about 5 meq/kg as determined by AOCS Cd 8-53; and a p-anisidine value of less than or equal to about 10 as determined by AOCS Cd 18-90;
   e) separating at least a portion of the solvent from the solvent-rich light phase; and
   f) combining the isolated solvent with additional crude Pongamia oil for liquid-liquid extraction.
80. The method of embodiment 79, wherein the continuous liquid-liquid extraction is performed using a forced agitated column.
81. The method of embodiment 80, wherein the forced agitated column is a forced agitated trayed column, the raffinate exits the column at the bottom, and the solvent-rich light phase exits the column at the top.
82. The method of any one of embodiments 79 to 81, wherein at least a portion of the solvent separated from the solvent-rich light phase is performed in an evaporator.
83. The method of embodiment 82, wherein the solvent is evaporated from the residual Pongamia oil under vacuum.
84. The method of embodiment 83, further comprising condensing the solvent, and stripping the solvent of any accumulated water in a stripping column.
85. The method of any one of embodiments 79 to 84, further comprising isolating the residual Pongamia oil in the solvent-rich light phase; and distilling solvent from the isolated residual Pongamia oil to produce additional Pongamia oil composition.
86. The method of any one of embodiments 77 to 85, wherein the elevated temperature is less than the boiling point of the immiscible solvent.
87. The method of embodiment 86, wherein the elevated temperature is between about 30° C. and about 75° C.
88. The method of any one of embodiments 77 to 87, wherein the ratio of solvent to crude Pongamia oil is between about 1:1 and about 5:1.
89. The method of any one of embodiments 77 to 88, wherein the crude Pongamia oil has an initial color, and the Pongamia oil composition produced has a final color, wherein the final color of the Pongamia oil composition is lighter than the initial color of the crude Pongamia oil.
90. The method of embodiment 89, wherein the initial color is red and/or brown, and the final color is yellow or light yellow.
91. The method of any one of embodiments 77 to 90, wherein the crude Pongamia oil is mechanically separated Pongamia oil.
92. The method of any one of embodiments 77 to 91, wherein the composition has one or more sensory attributes selected from the group consisting of: nuttiness, butteriness, grassiness, smoothness, and sweetness, and any combinations thereof, and wherein the composition is yellow.
93. The method of any one of embodiments 77 to 91, wherein the Pongamia oil composition the composition comprises less than or equal to about 200 ppm karanjin and pongamol combined, the composition has a neutral flavor, and the composition is light yellow.
94. A Pongamia oil composition produced according to the method of any one of embodiments 77 to 93.
95. Use of the Pongamia oil composition of any one of embodiments 57 to 76 and 94 as salad oil, frying oil, sauteeing oil, vinaigrettes, sauces, dressings, fats in meat mimetics, beverages, or blended margarines and other solid fat applications, or any combination thereof.
96. A food or beverage product, comprising the Pongamia oil composition of any one of embodiments 57 to 76 and 94.
97. The product of embodiment 96, wherein the composition is light yellow; the composition comprises less than or equal to about 200 ppm karanjin and pongamol combined, and the composition has a neutral flavor.
98. The product of embodiment 96, wherein the Pongamia oil composition is yellow; the composition comprises less than or equal to about 150 ppm karanjin and less than or equal to about 150 ppm pongamol; and the composition has one or more sensory attributes selected from the group consisting of; nuttiness, butteriness, grassiness, smoothness, and sweetness, and any combinations thereof.
99. The product of any one of embodiments 96 to 98, wherein the product is salad oil, frying oil, sauteeing oil, vinaigrettes, sauces, dressings, fats in meat mimetics, beverages, or blended margarines and other solid fat applications.
100. A Pongamia oil composition, having;
   (i) less than or equal to about 1000 ppm of karanjin and pongamol combined as determined by HPLC-DAD analysis of an acetone extract obtained from the Pongamia oil composition;
   (ii) less than or equal to about 1% by weight of unsaponifiable matter as determined by AOCS Ca 6a-40;
   (ii) a peroxide value of less than or equal to about 5 meq/kg as determined by AOCS Cd 8-53;
   (iv) a p-anisidine value of less than or equal to about 10 as determined by AOCS Cd 18-90;
   (v) less than or equal to about 5000 ppm of residual solvent as determined by AOCS Cg 4-94, wherein residual solvent, if present, is food grade solvent;
   (vi) at least 40% oleic acid present out of the total fatty acids as determined by AOAC 996.06;
   (vii) light yellow or yellow color;
   (viii) a neutral flavor, or one or more sensory attributes selected from the group consisting of; nuttiness, butteriness, grassiness, smoothness, and sweetness, and any combinations thereof; or
   (ix) any combinations of (i)-(viii) thereof.

### EXAMPLES

The presently disclosed subject matter will be better understood by reference to the following Examples, which are provided as exemplary of the invention, and not by way of limitation.

### Example 1

### Characterization of Pongamia Oil

This example provides the general protocol for characterizing Pongamia oil. The protocol provided herein and set forth in FIG. 1 was used to characterize the crude oil and the purified oil as described in the examples below, including Example 2.

A Pongamia oil sample was combined with acetone to prepare an extraction mixture. Then, the extraction mixture was sonicated to extract the liquid portion with karanjin and/or pongamol from the oil. This liquid portion was injected onto the HPLC column equilibrated with 40% acetonitrile for component analysis. Table 1 below summarizes HPLC-DAD settings used.

TABLE 1
Summary of basic HPLC-DAD settings

| Category | Description |
|---|---|
| Column | Agilent Poroshell C18, 4.6 × 100 mm, 2.6 μm |
| Column temperature | 35 ± 0.5° C. |
| Mobile phase A | HPLC Grade Water |
| Mobile phase B | Acetonitrile |
| Seal wash | 90:10 Water:Acetonitrile |
| Needle wash | 90:10 Acetonitrile:Water |
| Needle wash time | 6 seconds (Flush Port) |
| Flow rate | 0.800 mL/min |
| Injection volume | 1.0 μL |
| Signal A wavelength | 304 nm (bandwidth 4 nm) |
| Signal B wavelength | 350 nm (bandwidth 4 nm) |

Once the sample extract was loaded onto the C18 column equilibrated with 409% acetonitrile, the relative concentration of acetonitrile was, while maintaining the flow rate at 0.8 mL/min throughout, (i) linearly increased to 90% over 18 minutes, (ii) maintained at 90% for 4 minutes, (iii) linearly decreased to 40% over 1 minute, and (iv) maintained at 40% for 2 minutes, as summarized in Table 2 below.

TABLE 2
Elution program

| Time | Flow volume | A | B | Flow rate |
|---|---|---|---|---|
| (min) | (mL) | (%) | (%) | (mL/min) |
| 0 | 0 | 60 | 40 | 0.8 |
| 18 | 14.4 | 10 | 90 | 0.8 |
| 22 | 17.6 | 10 | 90 | 0.8 |
| 23 | 18.4 | 60 | 40 | 0.8 |
| 25 | 20 | 60 | 40 | 0.8 |

Karanjin was observed to elute around 9.6 minutes, corresponding to the relative acetonitrile concentration of around 67%. Pongamol was observed to elute around 14.4 minutes, corresponding to the relative acetonitrile concentration of around 80%. Based on the spectral analysis of elution fractions corresponding to karanjin and pongamol, the ppm concentration of each component was determined.

### Example 2

### Batch Production of Pongamia Oil

This example demonstrates the production of edible (e.g., non-bitter) Pongamia oil by liquid:liquid extraction of crude (e.g., bitter) Pongamia oil. Karanjin, pongamol, and potentially other anti-nutritional factors and/or bitterness compounds are removed from expeller-pressed Pongamia oil to give a purified oil product.

### Laboratory-Scale Batch Production

A laboratory-scale production to produce edible Pongamia oil was performed. Expeller-pressed Pongamia oil was filtered through diatomaceous earth to remove solid contents or solid waste. Then, the crude Pongamia oil was mixed with fresh 95% ethanol (5% water) in a 50 mL tube in a fixed volume ratio as indicated in Table 3. The mixture was heated to about 65° C. and agitated for 30 min before settling the mixture and decanting the solvent (ethanol) layer. It should be understood that the mixture can be heated to stay a few degrees below the boiling point of the solvent and/or to limit the loss of solvent vapors. The remaining liquid was cooled to 20° C. and let to settle. The solvent layer was decanted again, and the remaining oil was subject to the same process two more times, from mixing with fresh 95% ethanol in the fixed volume ratio.

The extraction coefficient indicates the ability of the extraction solvent to extract the targeted impurities from a given feedstock (e.g., the crude Pongamia oil in this case). The extraction coefficient is calculated as follows:

Extraction Coefficient=(Concentration of impurity in raffinate/Concentration of impurity in feedstock)

This laboratory-scale experiment explored different solvent-to-oil ratios, and showed that the extraction coefficient depends on the solvent-to-oil ratio, as summarized in Table 3 below.

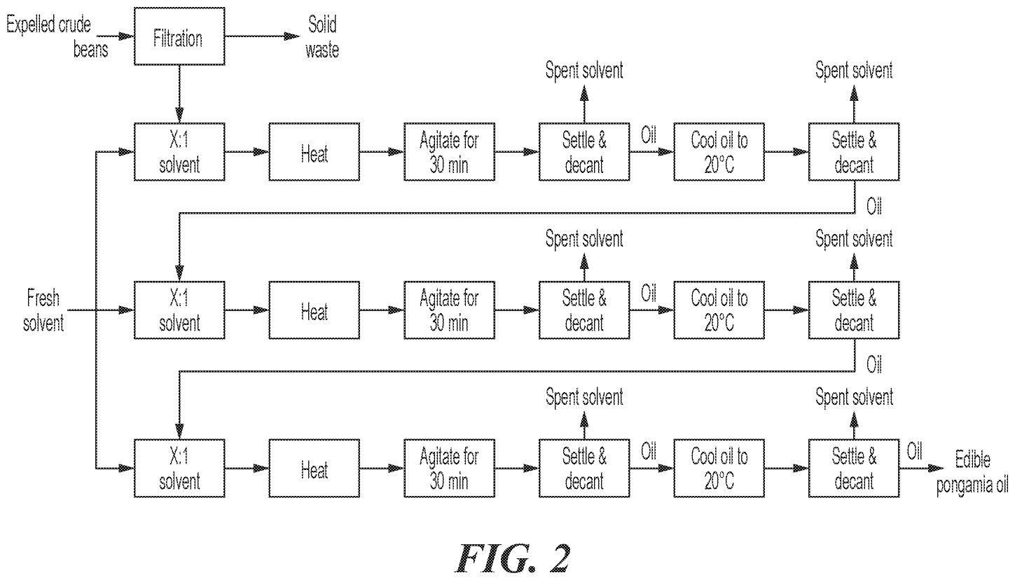

TABLE 3
Extraction coefficient (EC) for the
large-scale batch extraction method.

| | X value | | |
|---|---|---|---|
| Solvent:oil ratio | in FIG. 2 | EC for karanjin | EC for pongamol |
| 1:1 | 1 | 0.57 | 0.68 |
| 2:1 | 2 | 0.45 | 0.57 |
| 5:1 | 5 | 0.24 | 0.32 |
| 10:1 | 10 | 0.14 | 0.22 |

### Large-Scale Batch Production

A large-scale batch extraction was also performed in accordance with the procedure set forth in FIG. 2. Expeller-pressed Pongamia oil was filtered through diatomaceous earth to remove solid contents or solid waste. Then, the oil was mixed with fresh 95% ethanol (5% water) in mass ratio of solvent-to-oil of 5:1, in a 400 L stainless steel vessel with propeller-type agitators. The mixture was heated to 65° C. and agitated for 30 minutes before settling the mixture and decanting the solvent (ethanol) layer. It should be understood that the mixture can be heated to stay a few degrees below the boiling point of the solvent and/or to limit the loss of solvent vapors. The remaining liquid was cooled to 20° C. and let to settle. The solvent layer was decanted again, and the remaining oil was subject to the same process two more times, starting from mixing with fresh 95% ethanol in 5:1 solvent-to-oil mass ratio.

In each round of extraction, the pongamol content in the oil layer, as detected by the analytical method set forth in Example 1 above, was observed to decrease from 2342 ppm to 650 ppm, to 192 ppm, and finally to 54 ppm. Likewise, in each round of extraction, the karanjin content in the oil layer was observed to decrease from 11935 ppm to 2306 ppm, to 516 ppm, and finally to 91 ppm. The average extraction coefficient for karanjin was 0.2, and that for pongamol was 0.28. After all three rounds of extractions, the Pongamia oil was observed to have a non-bitter taste with karanjin and pongamol levels less than 100 ppm respectively. Tables 4-8 below summarizes various compositions and properties of the edible Pongamia oil produced in this example.

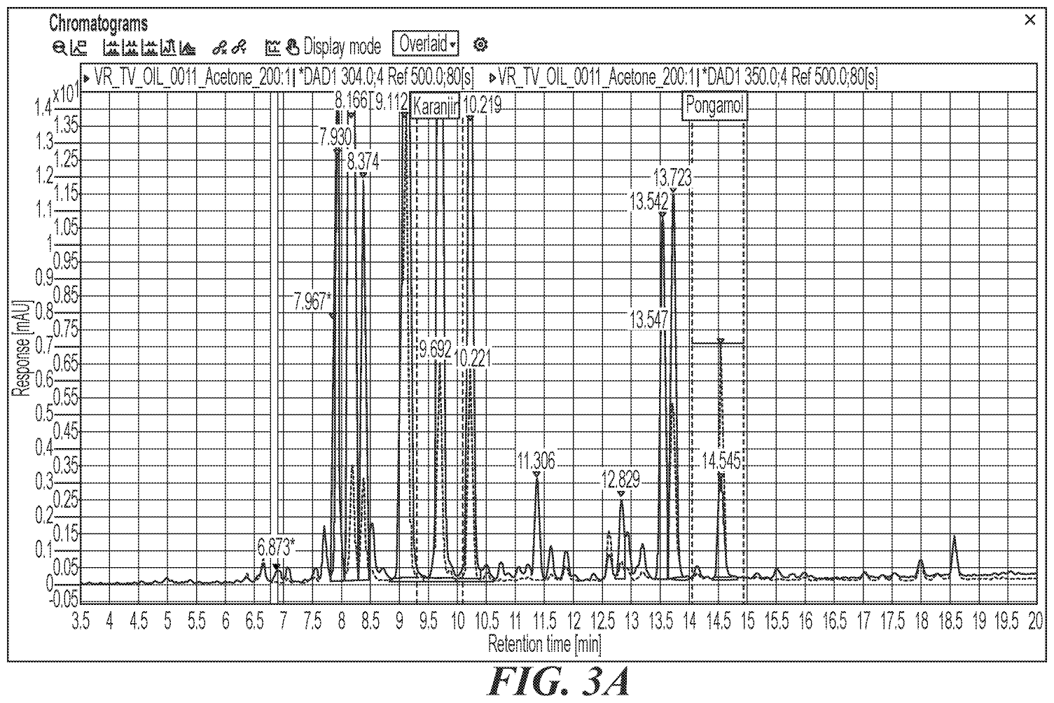

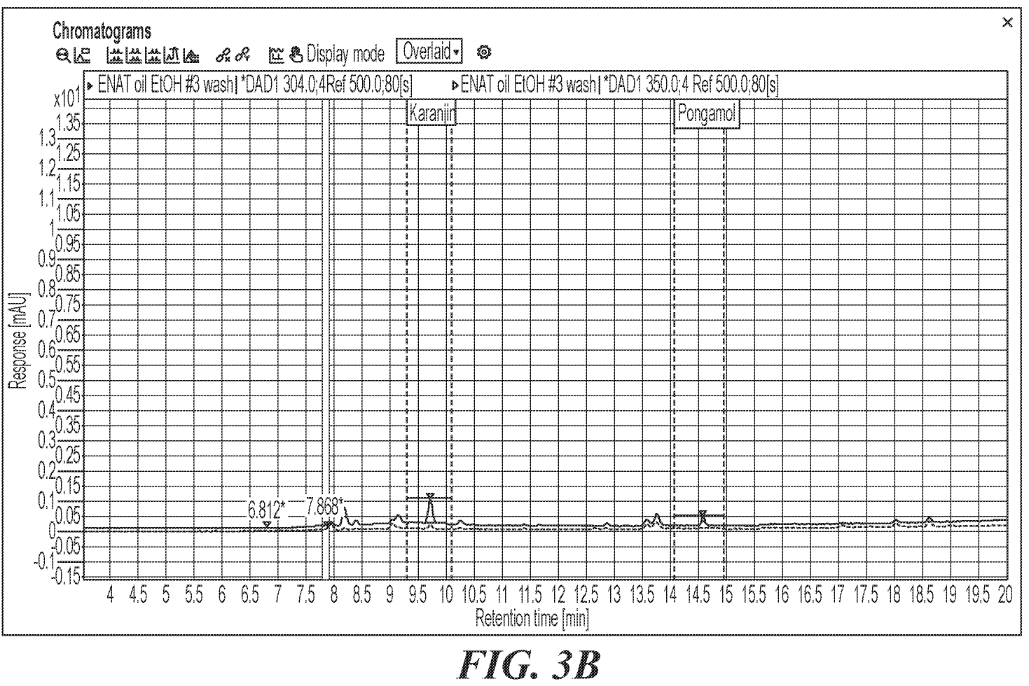

The analytical method described in Example 1 above was also used to characterize the karanjin and pongamol in the crude oil and purified oil of this example. In large-scale batch production, the resulting removal of furanoflavonoid class compounds was revealed by HPLC chromatography. FIGS. 3A and 3B also compare the removal of furanoflavonoids and other chemicals from edible oil in the crude oil and purified oil of this example.

Table 4 below compares the amount of fatty acid compositions of crude Pongamia oil (“crude oil”) with the Pongamia oil purified in accordance with the procedure set forth in this example (“purified oil”). The methods used to determine the components measured are set forth in Table 4. The methods used to determine the components measured are set forth in Table 4, where AOAC refers to the Association of Official Analytical Chemists and their test methods are publicly available.

TABLE 4
Fatty acid composition (% of total)*

| Fatty | | Crude | Purified | |
|---|---|---|---|---|
| acid | Common name | oil | oil | Test method |
| 14:0 | Myristic acid | 0.03 | 0.03 | AOAC 996.06 |
| 16:0 | Palmitic Acid | 8.26 | 8.54 | AOAC 996.06 |
| 16:1c9 | Palmitoleic Acid | <0.04 | 0.06 | AOAC 996.06 |
| Σ16:1 | Total Palmitoleic Acid + | 0.09 | 0.06 | AOAC 996.06 |
| | isomers | | | |
| 17:0 | Margaric Acid | 0.08 | 0.09 | AOAC 996.06 |
| 17:1c9 | Heptadecenoic Acid | 0.04 | 0.05 | AOAC 996.06 |
| 18:0 | Stearic Acid | 6.08 | 7.16 | AOAC 996.06 |
| 18:1c11 | Vaccenic acid | 0.55 | 0.53 | AOAC 996.06 |
| 18:1c9 | Oleic Acid | 44.87 | 49.84 | AOAC 996.06 |
| Σ18:1 | Total Oleic Acid + isomers | 45.62 | 50.37 | AOAC 996.06 |
| 18:2n6 | Linoleic Acid | 15.64 | 15.98 | AOAC 996.06 |
| Σ18:2 | Linoleic Acid + isomers | 15.76 | 15.98 | AOAC 996.06 |
| 18:3n3 | Alpha Linolenic Acid | 2.18 | 2.14 | AOAC 996.06 |
| Σ18:3 | Total Linolenic Acid + | 2.18 | 2.14 | AOAC 996.06 |
| | isomers | | | |
| 20:0 | Arachidic Acid | 1.15 | 1.5 | AOAC 996.06 |
| 20:1c11 | Gondoic Acid | 0.90 | 1.18 | AOAC 996.06 |
| Σ20:1 | Total Gondoic Acid + | 0.95 | 1.18 | AOAC 996.06 |
| | isomers | | | |
| 20:2n6 | Eicosadienoic Acid | 0.15 | 0.13 | AOAC 996.06 |
| 22:0 | Behenic Acid | 2.87 | 4.16 | AOAC 996.06 |
| 22:1c13 | Erucic Acid | 0.06 | 0.08 | AOAC 996.06 |
| Σ22:1 | Total Erucic Acid + | 0.06 | 0.08 | AOAC 996.06 |
| | isomers | | | |
| 24:0 | Lignoceric Acid | 1.13 | 1.74 | AOAC 996.06 |

*The following fatty acids have less than 0.02% of total fatty acids: C4:0, 6:0, 8:0, 10:0, 11:0, 12:0, 14:0, 14:1c9. 15:0, 15:1, 16:2, 16:3, 16:4, 18:3n6, 18:4n3, 20:3n3, 20:3n6, 20:4n6, 20:5n3, 22:2n6, 22:3n3, 22:4n6, 22:5n3, 22:5n6, 22:6n3, 24:1n9

Table 5 below compares the amount of fatty acid classes in the crude oil with the purified oil. The methods used to determine the components measured are set forth in Table 5.

TABLE 5
Fatty acid classes

| | Crude | Purified | |
|---|---|---|---|
| Class | oil | oil | Test method |
| Total Identified Fatty Acids | 84.72 | 93.26 | AOAC 996.06 |
| Total Monounsaturated Fatty Acids | 46.59 | 51.77 | AOAC 996.06 |
| Total Polyunsaturated Fatty Acids | 18.3 | 18.26 | AOAC 996.06 |
| Total Saturated Fatty Acids | 19.62 | 23.23 | AOAC 996.06 |
| Total Trans Fatty Acids | 0.22 | <0.02 | AOAC 996.06 |
| Total Omega 3 Fatty Acids | 2.41 | 2.15 | AOAC 996.06 |
| Total Omega 6 Fatty Acids | 15.8 | 16.1 | AOAC 996.06 |
| Total Omega 7 Fatty Acids | 0.58 | 0.65 | AOAC 996.06 |
| Total Omega 9 Fatty Acids | 46.57 | 51.07 | AOAC 996.06 |

Table 6 below compares the chemical compositions of the crude oil with the purified oil. The methods used to determine the components measured are set forth in Table 6, where AOCS refers to the American Oil Chemists' Society and their test methods are publicly available.

TABLE 6
Chemical composition

| | Crude | Purified | |
|---|---|---|---|
| Component (unit of measure) | oil | oil | Test method |
| Free Fatty Acids (FFA) | 1.2 | 0.03 | AOCS Ca 5a-40 |
| Peroxide Value (meq/kg) | 3.3 | 3.8 | AOCS Cd 8-53 |
| p-Anisidine Value | Not | 4.2 | AOCS Cd 18-90 |
| | Applicable | | |
| Neutral Oil (%) | 97.68 | 99.75 | AOCS Ca 9f-57 |
| Insoluble impurities (%) | 0.03 | 0.06 | AOCS Ca 3a-46 |
| Unsaponifiable matter (%) | 0.81 | 0.26 | AOCS Ca 6a-40 |
| Soap Content (g/kg) | <0.0227 | <0.1 | AOCS CC17-95, |
| | | | CC15-60 |
| OSI (Oxidative Stability | 8.16 | 2.17 | AOCS Cd 12b-92: |
| Index; hours) | | | 1997 |
| Phosphorus (oil specific) | 9.1 | 11 | AOCS Ca 20-99, |
| (ppm) | | | mod. |
| Chlorophyll (ppm) | 1 | 0.5 | AOCS Ch 4-91 |
| Moisture (%) | 0.09 | 0.04 | AOCS Ca 2b-38 |
| Lovibond Color - AOCS | 1.8R, | 1.4R, | AOCS Cc 13b-45 |
| Scale | 70Y | 38.0Y | |
| Smoke point (° F.) | 336 | 437 | AOCS Cc 9a-48 |
| Glycerol % | <1 | <1 | AOCS Cd 11c-93 |
| Monoglycerides % | 7.1 | 1.2 | AOCS Cd 11c-93 |
| Diglycerides % | 9.4 | 1.6 | AOCS Cd 11c-93 |
| Triglycerides % | 86.3 | 97.43 | AOCS Cd 11c-93 |
| Ethanol residual (ppm) | Not | 962 | AOCS Cg 4-94 |
| | Applicable | | |

Table 7 below compares the tocopherol content in the crude oil with the purified Pongamia oil. The methods used to determine the components measured are set forth in Table 7.

TABLE 7
Tocopherol content

| | Crude | Purified | |
|---|---|---|---|
| Tocopherol | oil | oil | Test method |
| Alpha- Tocopherol | 288 | <48.9 | AOAC 971.30 with HPLC |
| Beta-Tocopherol | <490 | <48.9 | AOAC 971.30 with HPLC |
| Delta-Tocopherol | <490 | <48.9 | AOAC 971.30 with HPLC |
| Gamma-Tocopherol | 191 | <48.9 | AOAC 971.30 with HPLC |
| Total Tocopherols | 479 | <48.9 | AOAC 971.30 with HPLC |

Table 8 below compares the sterol content in the crude oil with the purified oil. The methods used to determine the components measured are set forth in Table 8, where “COI/T.20/Doc No. 10” is a publicly available test method put forth by the International Olive Council.

TABLE 8
Sterol content

| | Crude | Purified | |
|---|---|---|---|
| Sterol | oil | oil | Test method |
| 24-Methylene-cholesterol (% | 0.18 | 0.36 | COI/T.20/Doc No. 10 |
| total sterols) | | | |
| Apparent Beta-Sitosterol (% | 57.38 | 68.7 | COI/T.20/Doc No. 10 |
| total sterols) | | | |
| Beta-Sitosterol “real” (% total | 52.62 | 60.72 | COI/T.20/Doc No. 10 |
| sterols) | | | |
| Brassicasterol (% total sterols) | 1.11 | 1.68 | COI/T.20/Doc No. 10 |
| Campestanol (% total sterols) | <0.01 | 0.35 | COI/T.20/Doc No. 10 |
| Campesterol (% total sterols) | 9.36 | 14.35 | COI/T.20/Doc No. 10 |
| Cholesterol (% total sterols) | 0.15 | 0.19 | COI/T.20/Doc No. 10 |
| Clerosterol (% total sterols) | 0.62 | 0.72 | COI/T.20/Doc No. 10 |
| Delta-5,23-stigmastadienol (% | <0.01 | <0.01 | COI/T.20/Doc No. 10 |
| total sterols) | | | |
| Delta-5,24-stigmastadienol (% | <0.01 | 0.2 | COI/T.20/Doc No. 10 |
| total sterols) | | | |
| Delta-5-avenasterol (% total | 3.22 | 6.25 | COI/T.20/Doc No. 10 |
| sterols) | | | |
| Delta-7-avenasterol (% total | <0.01 | 0.55 | COI/T.20/Doc No. 10 |
| sterols) | | | |
| delta-7-Campesterol (% total | <0.01 | <0.01 | COI/T.20/Doc No. 10 |
| sterols) | | | |
| Delta-7-stigmastenol (% total | 1 | 0.2 | COI/T.20/Doc No. 10 |
| sterols) | | | |
| Sitostanol (% total sterols) | 0.93 | 0.81 | COI/T.20/Doc No. 10 |
| Stigmasterol (% total sterols) | 30.81 | 13.61 | COI/T.20/Doc No. 10 |
| Total sterol - (mg/kg fat) | 3090 | 1160 | COI/T.20/Doc No. 10 |

Table 9 below compares the karanjin and pongamol content in the crude oil with the purified oil. The karanjin and pongamol contents were determined in accordance with the protocol described in Example 1 above.

TABLE 9
Karanjin and pongamol content (ppm)

| Pongamia-specific furanoflavonoids | Crude oil | Purified oil |
|---|---|---|
| Karanjin | 11,935 | 91 |
| Pongamol | 2,342 | 54 |

Table 10 below compares the color of the crude oil with the purified oil. The method used to determine color are set forth in Table 10.

TABLE 10
Lovibond color description

| | Lovibond color | | | |
|---|---|---|---|---|
| | Red | Yellow | Description | |
| Oil type | (0-20) | (0-70) | of color | Test method |
| Crude oil | 1.8 | 70 | brownish red | AOCS Cc 13b-45 (5.25- |
| | | | | inch cell path) |
| Purified | 1.4 | 38 | yellow | AOCS Cc 13b-45 (5.25- |
| oil | | | | inch cell path) |

### Example 3

### Continuous Production of Pongamia Oil

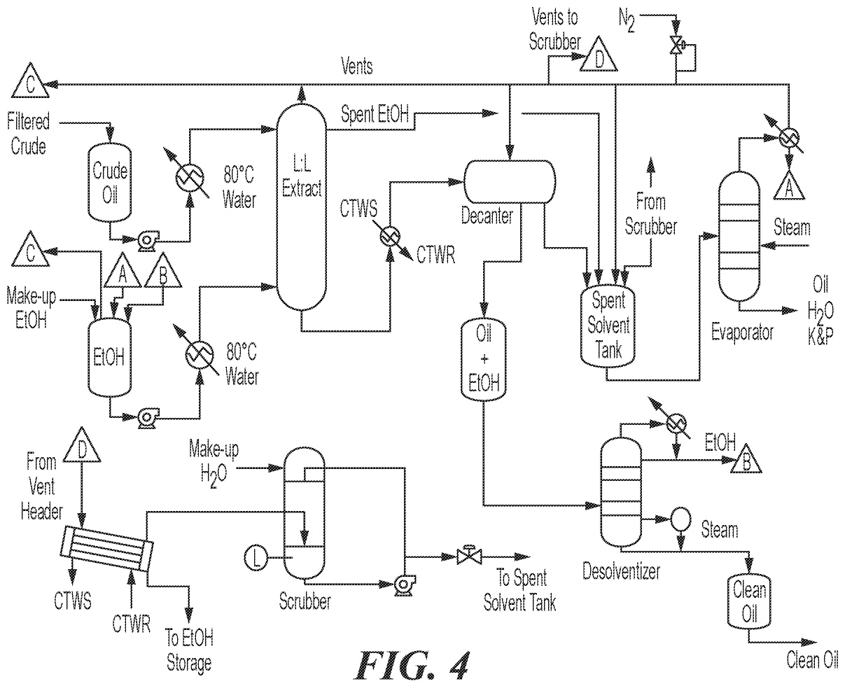

This example describes a continuous countercurrent process to produce edible Pongamia oil from mechanically separated crude Pongamia oil, and generally follows the exemplary system set forth in FIG. 4.

Edible Pongamia oil is produced by continuous liquid-liquid extraction of filtered crude Pongamia oil with 96% ethanol. The liquid-liquid extraction equipment includes a forced agitated trayed column, with the 70° C. crude oil and solvent streams entering the column at the top and bottom respectively. The raffinate (the heavier oil layer) exits the column at the bottom, and the lighter solvent layer exits the column at the top. The column includes a number of physical stages that is equal to the number of theoretical stages, plus a number of additional stages to account for deviations from the theoretical oil/solvent equilibrium conditions. The amount of karanjin and pongamol present in the raffinate exiting the column at the bottom is measured in accordance with the analytical method set forth in Example 1 above. When the raffinate contains less than 150 ppm of karanjin and/or pongamol, and a percentage of solvent that is equivalent to the liquid-liquid equilibrium composition of ethanol and Pongamia oil at the mixture temperature, the raffinate is cooled (e.g., by means of a cooling tower; CTWS=cooling tower water supply: CTWR=cooling tower water return) and the solvent is allowed to further separate and decanted from the oil in the decanter. The oil is then stripped of any residual solvent by vacuum steam stripping in the stripper column.

The lighter solvent layer exiting the top of the column is sent to the evaporator where the solvent is evaporated from the oil under vacuum. The solvent from the evaporator is condensed and further stripped of any accumulated water in an ethanol distillation column to 95% ethanol purity. The purified ethanol is recycled back to the liquid-liquid extraction column. The residual solvent-free oil from the solvent recovery evaporator contains the impurities that have been removed from the crude oil. Additional oil is further recovered from the residual oil stream by distillation. The impurities from the oil are isolated and concentrated in a liquid stream with oil as solvent, and is stored for further processing.

### Example 4

### Batch Production of Pongamia Oil and Sensory Evaluation of Pongamia Oil

The present example details batch production of purified Pongamia oil by liquid-liquid extraction.

Crude Pongamia oil used in the present example was taken from the same crude oil sample as provided in Example 2 (crude Pongamia oil, Ex. 2) or was obtained from pressing from Pongamia beans (crude Pongamia oil, Ex. 4). The crude Pongamia oil of Example 2 was used as the starting oil for purified oil samples #1-#3. Purified Pongamia oil sample #1 was the same sample as obtained in Example 2.

The extraction tank system consisted of a conical bottom stainless steel reactor vessel, equipped with top mounted vertical shaft with 4 propeller-type agitators mounted. The vessel was equipped with sealed internal coils for heating or cooling, e.g. using steam.

Table 11 below shows the process parameters used to obtain the different purified Pongamia oil samples.

TABLE 11
Process Parameters

| | No. of Batch | |
|---|---|---|
| Process Run (Sample #) | washes | Temperature |
| #1 (see Example 2, purified oil) | 3 | 70° C. |
| #2 | 3 | 70° C. |
| #3 | 3 | 70° C. |

First wash: Crude Pongamia oil was first transferred into extraction tank, followed by ethanol (5 times weight of crude oil). Once the crude oil and ethanol had been added, agitation was started. For trial runs in which the target temperature for the extraction was above ambient temperature, the tank contents were heated to the target temperature (e.g., 70° C.). Once at the desired temperature, the tank contents were agitated for 30 minutes. After 30 minutes, agitation was stopped and the oil and solvent were allowed to separate undistributed for approximately 3-5 minutes. The oil from the first wash was then carefully decanted from the ethanol in the tank, and the spent ethanol drained from the tank. The wash procedure was repeated two additional times. Samples of the washed oil and spent ethanol were taken after the first, second, and third washes to monitor karanjin and pongamol content, peroxide values and p-anisidine values during the extraction process.

Decanting and Desolventization: Once the desired number of washes had been completed, the oil obtained from the final wash was decanted and subjected to de-solventization. The oil obtained from the final wash was placed in a container and immersed in a hot water bath (45° C.) for at least 5 minutes to induce phase separation; the oil and ethanol were then separated by decanting. After decanting, the decanted oil was de-solventized by rotary evaporator (rotovap) with a water bath set at 55° C. for the first 90 minutes, until no more condensate (ethanol) droplets were observed, and then at 60° C. a second 90-minute period, until no more condensate (ethanol) droplets were observed

After extraction, the purified Pongamia oil samples were analyzed for karanjin and pongamol content, residual solvent content, sensory profile (including taste and smell), peroxide values and p-anisidine values. Table 12 shows the karanjin content, pongamol content, peroxide value and p-anisidine vale of the final purified Pongamia oil samples taken from each process run.

TABLE 12
Analytical Results: Karanjin and Pongamol Content,
Peroxide Values and p-Anisidine Values

| Process Run | Crude oil, | #1 (Purified oil, | | |
|---|---|---|---|---|
| (Sample #) | Ex. 2 | Ex. 2) | #2 | #3 |
| Karanjin (ppm) | 11,935 | 91 | 71 | 125 |
| Pongamol (ppm) | 2,342 | 54 | 48 | 80 |
| Peroxide Value (meq/kg) | 3.3 | 3.8 | 3.4 | 1.7 |
| p-Anisidine Value | ND | 4.2 | 4.2 | 5.9 |

### Pongamia Oil Sensory Evaluation

Internal Pongamia oil tasting involved the participation of 6 individuals. Each participant was asked to assess each oil sample on the basis of color, turbidity, odor, taste, and overall acceptability. For taste and smell evaluation, the participants perform free choice profiling by blindly tasting each purified Pongamia oil sample and assigning attributes that they believe best describe the flavor of each oil sample.

Samples #1-3 were found to have light yellow color, no turbidity, and no odor. The descriptors that appeared frequently in the taste profiles of these purified Pongamia oil samples in the free choice profiling were: clean, nutty, smooth, buttery, and clean. Additional descriptors included no bitterness, Pongamia notes, and slight grassiness. Table 13 below summarizes the organoleptic properties of the Pongamia oil samples obtained from the various process runs.

TABLE 13
Sensory Evaluation of Batch-Produced Purified Pongamia Oil

| Process | | |
|---|---|---|
| Run | | |
| (Sample #) | Color | Sensory |
| #1 | Light yellow | Clean, nutty, smooth taste, no bitterness |
| #2 | Light yellow | Pongamia nutty taste, faint nutty smell, |
| | | buttery, smooth |
| #3 | Light yellow | Nutty, slight pongamia taste, clean taste, |
| | | smooth, buttery |

### Example 5

### Continuous Production of Pongamia Oil and Sensory Evaluation of Pongamia Oil

This example describes a continuous countercurrent process to produce edible Pongamia oil from mechanically separated crude Pongamia oil. The elevated temperature and solvent to crude Pongamia oil ratio were varied. The resulting purified Pongamia oil samples were evaluated for their final karanjin and Pongamia content, their color and smell and taste.

Edible Pongamia oil is produced by continuous liquid-liquid extraction of filtered crude Pongamia oil with ethanol. The liquid-liquid extraction equipment was carried out using one of two types of forced agitated trayed columns. For both column types, the column was first filled with solvent to the feed inlet location at the desired solvent flow rate. Next, the crude oil was fed into the column at the desired rate. Once an interface was established in the bottom disengaging chamber, bottoms take off was begun and the interface controlled by adjusting the bottoms take-off rate. After one column turnover (total column volume divided by the combined feed and solvent flow rates), adjustments were made to the column agitation to increase to the desired stroke/rotation rate. Agitation was set prior to two column turnovers. The column was operated for a total of five (5) turnovers before sampling the raffinate and extract phases. Prior to sampling, extract and raffinate rates were manually taken by the operators. After the first run, and following adjustment of variables specified by the engineer, a total of three (3) turnovers were performed before sampling each run. Adjustments in solvent to feed (S/F) ratio and capacity were made by increasing or decreasing the feed and solvent inlet rates. Adjustments in temperature were made by increasing or decreasing the temperature of the hot oil to the feed and solvent preheaters and adjusting the heat tapes on the column.

The amount of karanjin and pongamol present in the raffinate exiting the column at the bottom was measured in accordance with the analytical method set forth in Example 1 above. Table 14 below shows process parameters and observed K+P. As illustrated below, it was observed that process runs conducted at 25° C. (#4-#7) did not achieve sufficient removal of karanjin and pongamol for downstream use. However, for the process runs carried out at elevated temperatures (#8-#15) resulted in substantial removal of karanjin and pongamol, in some cases to non-detectable levels.

TABLE 14
Continuous Process Parameters and
Karanjin and Pongamol Content

| | | | | Target | |
|---|---|---|---|---|---|
| Process Run | Karanjin | Pongamol | Solvent:Oil | Temp | |
| (Sample #) | (ppm) | (ppm) | Ratio | (° C.) | Stages |
| Crude Oil | 12,251 | 5662 | — | — | — |
| #4 | 10,571 | 3165 | 5:1 | 25 | — |
| #5 | 8133 | 2575 | 5:1 | 25 | — |
| #6 | 6210 | 2095 | 5:1 | 25 | — |
| #7 | 9945 | 3068 | 4:1 | 25 | — |
| #8 | 177 | 84 | 10:1 | 50-55 | — |
| #9 | 305 | 205 | 5:1 | 50-55 | — |
| #10 | ND | ND | 5:1 | 50-55 | 100 |
| #11 | ND | ND | 4:1 | 50-55 | 100 |
| #12 | <10 | <10 | 3:1 | 50-55 | 100 |
| #13 | <10 | 34 | 3:1 | 50-55 | 76 |
| #14 | 11 | 152 | 2:1 | 50-55 | 76 |
| #15 | <10 | 101 | 2:1 | 50-55 | 100 |

*ND = not detectable

Table 15 below shows the composition of one purified Pongamia oil composition (process run #13) obtained herein as compared to the starting crude Pongamia oil. Table 16 shows the fatty acid composition of purified Pongamia oil obtained from process run #13.

TABLE 15
Analytical Results

| | | Process Run |
|---|---|---|
| | Clarified | (Sample) |
| Sample type | crude oil | # 13 |
| Karanjin (ppm) | 12251 | <10 |
| Pongamol (ppm) | 5662 | 34 |
| Residual EtOH (ppm) | ND | <10 |
| Moisture and volatiles % | 0.11 | 0.7 |
| PV (meq/kg) | 0.7 | 0.7 |
| P-anisidine | Not determined | 7 |
| OSI (hours) | 13.97 | Not determined |
| FFA % | 5.1 | 0.05 |
| Color (Lovibond)-1″ cell path (Red) | | 2.4 |
| Color (Lovibond)-1″ cell path (Yellow) | | 24 |
| Color (Lovibond Scale)-5.25″ cell path | | 10.2 |
| (Red) | | |
| Color (Lovibond Scale)-5.25″ cell path | | 70 |
| (Yellow) | | |
| Unsaponifiable matter % | Not determined | 0.28 |

TABLE 16
Fatty acid profile of Process Run #13

| | Absolute FA % | Relative to total FA % |
|---|---|---|
| Myristic acid | 0.04 | 0.04 |
| Palmitic Acid | 9.18 | 10.17 |
| Palmitoleic Acid | 0.06 | 0.07 |
| Stearic Acid | 6.97 | 7.72 |
| Vaccenic acid | 0.42 | 0.47 |
| Oleic Acid | 47.47 | 52.60 |
| Linoleic Acid | 15.98 | 17.71 |
| Linolenic Acid | 2.56 | 2.84 |
| Arachidic Acid | 1.44 | 1.60 |
| Gondoic Acid | 0.91 | 1.01 |
| Eicosapentaenoic Acid | 0.03 | 0.03 |
| Behenic Acid | 3.44 | 3.81 |
| Erucic Acid | 0.05 | 0.06 |
| Lignoceric Acid | 1.1 | 1.22 |
| Nervonic Acid | <0.02 | <0.02 |
| Total Omega 3 Isomers | 2.63 | 2.91 |
| Total Omega 6 Isomers | 16.04 | 17.77 |
| Total Omega 7 Isomers | 0.45 | 0.50 |
| Total Omega 9 Isomers | 48.45 | 53.69 |
| Monounsaturated FAs | 49.07 | 54.38 |
| Polyunsaturated FAs | 18.77 | 20.80 |
| Saturated FAs | 22.28 | 24.69 |
| Trans FAs | 0.12 | 0.13 |
| Total Fat as Triglycerides | 94.29 | — |
| Total Fatty Acids | 90.24 | — |

### Pongamia Oil Sensory Evaluation

Internal Pongamia oil tasting involved the participation of 6 individuals. Each participant was asked to assess each oil sample on the basis of color, turbidity, odor, taste, and overall acceptability. For taste and smell evaluation, the participants perform free choice profiling by blindly tasting each purified Pongamia oil sample and assigning attributes that they believed to best describe the flavor of each oil sample. The free choice descriptors were aggregated for each sample and are shown in Table 17.

TABLE 17
Sensory characteristic profiles

| Process | | |
|---|---|---|
| Run | Color, | |
| (Sample#) | Turbidity | Sensory Characteristics (Smell, Taste) |
| Crude | Brownish red | Sharp bitter taste, unpleasant sourness, |
| Oil | | tingling sensation in back of throat, |
| | | unacceptable |
| #10 | Light yellow | Smell: no ethanol, no significant pongamia |
| | | note, mild, neutral odor Taste: slight |
| | | nuttiness, slightly buttery more clean to |
| | | bland, little taste, smooth, bland, neutral, no |
| | | flavor |
| #11 | Light yellow | Smell: no ethanol, no significant pongamia |
| | to golden | note, mild, no/neutral odor, slight ethanol |
| | with some | Taste: clean, slightly buttery, nutty, slight |
| | haziness | burn in the throat, little taste, bland, |
| | | astringent, slightly bitter |
| #12 | Slightly | Smell: no ethanol, no significant pongamia |
| | brown to | aroma, mild, no/neutral odor, slight ethanol |
| | yellow | Taste: slightly buttery, nutty, bland, smooth, |
| | | sweet, oily, slight burn |
| #13 | Light yellow | Smell: no ethanol, no significant pongamia |
| | | note/aroma Taste: buttery, smooth, nutty, |
| | | bland, little taste, tasteless, astringent, not |
| | | much mouthfeel |
| #14 | Light yellow | Smell: no/mild ethanol, no significant |
| | | pongamia note/aroma, nutty smell Taste: |
| | | buttery, nutty, smooth, lingering slight sour, |
| | | slight burn in the throat, slight pongamia |
| | | taste, little something |
| #15 | Light yellow | Smell: no/trace ethanol, no significant |
| | to yellow | pongamia note, mild, no/neutral odor Taste: |
| | | mild grassy, buttery, nutty, classic pongamia, |
| | | most nutty flavor, slight burn on throat, |
| | | smooth, pongamia taste |

### Example 6

### Thermal Properties of Purified Pongamia Oil

The present example details evaluation of the thermal and temperature-dependent physical properties of purified Pongamia oil.

Purified Pongamia oil was obtained in accordance with the protocol described in Example 4. Solid fat content (SFC) was measured using Nuclear Magnetic Resonance (NMR) following AOCS-Cd 16b-93. In addition, flash point, dropping point and smoke point were determined on the same sample in accordance with AOCS Cc 9b-55, AOCS Cc 18-80, and AOCS Cc 9a-48, respectively. Table 18 summarizes the results recorded for various metrics.

TABLE 18
Thermal and Physical Properties of Pongamia Oil

| Measurement Method | | Unit | Value |
|---|---|---|---|
| Flash Point (AOCS | Flash Point | ° C. | 245 |
| Cc 9b-55) | | | |
| Dropping Point | Dropping Point | ° C. | <20.0 |
| (AOCS Cc 18-80) | | | |
| Solid Fat Content | SFC@2.5 C. | % | 8.88 |
| (AOCS-Cd 16b-93) | SFC@5.0 C. | % | 8.53 |
| | SFC@10.0 C. | % | 5.1 |
| | SFC@21.1 C. | % | 0 |
| Smoke Point (AOCS | Smoke Point | ° C. | 195 |
| Cc 9a-48) | | | |

For solid fat content measurements, Pongamia oil was observed to have 1-10% solid fat content from 2.5-10° C., and 0% solid fat content at 21.1° C. and higher. Melting (heating) and crystallization (cooling) profiles of Pongamia oil were studied using differential scanning calorimetry (DSC). Pongamia oil was observed to contain two fractions with different thermal properties.

### Example 7

### Food Products

This example provides various examples of food products that can be produced using the Pongamia oil compositions obtained in accordance with the protocols set forth in Examples 1-5 above. Table 19 provides an exemplary formula for Pongamia oil mayonnaise. Table 20 provides an exemplary formula for Pongamia oil margarine and spread. Table 21 provides an exemplary formula for Pongamia oil salad dressing.

TABLE 19
Pongamia Oil Mayonnaise Formula

| Ingredient | Wt % |
|---|---|
| Pongamia oil | 75 |
| Egg yolk | 6 |
| Vinegar 5% (w/v) | 10 |
| Salt | 1.1 |
| Sugar | 2.5 |
| Water | 4.5 |
| Mustard | 1.5 |
| Guar gum | 0.4 |
| Potassium Sorbate | 0.07 |
| Sodium benzoate | 0.03 |

TABLE 20
Pongamia Oil Margarine and Spread Formulas

| | Wt % in Finished Product | | |
|---|---|---|---|
| Ingredient | 80% Fat | 60% Fat | 40% Fat |

Oil phase

| | | | |
|---|---|---|---|
| Liquid and fully hydrogenated pongamia | 79.884 | 59.584 | 39.384 |
| oil blend | | | |
| Soybean lecithin | 0.1 | 0.1 | 0.1 |
| Soybean oil mono- and diglycerides (IV | 0.2 | 0.3 | — |
| 5, max.) | | | |
| Soybean oil monoglyceride (IV 60) | — | — | 0.5 |
| Vitamin A palmitate-b-carotene blend | 0.001 | 0.001 | 0.001 |
| Oil-soluble flavor | 0.015 | 0.015 | 0.015 |

Aqueous phase

| | | | |
|---|---|---|---|
| Water | 16.2 | 37.36 | 54.86 |
| Gelatin (250 bloom) | — | — | 2.5 |
| Spray-dried whey | 1.6 | 1 | 1 |
| Salt | 2 | 1.5 | 1.5 |
| Sodium benzoate | 0.09 | — | — |
| Potassium sorbate | — | 0.13 | 0.13 |
| Lactic acid | — | to pH 5 | to pH 4.8 |
| Water-soluble flavor | 0.01 | 0.01 | 0.01 |

TABLE 21
Pongamia Oil Salad Dressing Formula

| Ingredient | Wt % |
|---|---|
| Water | 15 |
| Apple vinegar | 12 |
| Apple juice | 12 |
| Honey | 10 |
| Pongamia oil | 42 |
| Mustard powder | 5 |
| Xanthan gum | 0.5 |
| Pregelatinized potato starch | 0.5 |
| Colourant E-150d | 0.5 |
| Acidulant E-330 | 0.1 |
| Preservative E-202 | 0.1 |
| Salt | 1 |
| Sugar | 1.3 |

The term “about” as used herein refers to the usual error range for the respective value readily known to the skilled person in this technical field. Reference to “about” a value or parameter herein includes (and describes) embodiments that are directed to that value or parameter per se. For example, “about x” includes and describes “x” per se. In some embodiments, the term “about” when used in association with a measurement, or used to modify a value, a unit, a constant, or a range of values, refers to variations of +/−2% of the stated value or parameter.

Reference to “between” two values or parameters herein includes (and describes) embodiments that include those two values or parameters per se. For example, description referring to “between x and y” includes description of “x” and “y” per se.

1. A Pongamia oil composition, having:
less than or equal to about 1000 ppm of karanjin and pongamol combined;
less than or equal to about 1% by weight of unsaponifiable matter;
a peroxide value of less than or equal to about 5 meq/kg;
a p-anisidine value of less than or equal to about 10; and
less than or equal to about 5000 ppm of residual solvent, wherein residual solvent, if present, is food grade solvent.

2. The composition of claim 1, having:
less than or equal to about 150 ppm of karanjin;
less than or equal to about 150 ppm of pongamol;
less than or equal to about 1% by weight of unsaponifiable matter;
a peroxide value of less than or equal to about 5 meq/kg;
a p-anisidine value of less than or equal to about 5; and
less than or equal to about 5000 ppm of residual solvent, wherein residual solvent, if present, is food grade solvent.

3. The composition of claim 1, wherein the composition comprises less than or equal to about 1000 ppm of residual solvent.

4. The composition of claim 1, wherein the residual solvent comprises ethanol.

5. The composition of claim 1, wherein the composition is liquid at room temperature.

6. The composition of claim 1, wherein the composition has a viscosity of between about 30 centipoise and 600 centipoise as determined at 25° C.

7. The composition of claim 1, wherein the composition has a solid fat content of between about 1% and about 10% at a temperature of about 5° C.

8. The composition of claim 1, wherein the composition has a smoke point of at least about 195° C.

9. The composition of claim 1, wherein the composition has less than or equal to about 400 ppm of tocopherols.

10. The composition of claim 1, wherein the composition wherein the composition has less than 2500 ppm of sterols.

11. The composition of claim 1, wherein the composition comprises oleic acid, linoleic acid, palmitic acid, stearic acid, behenic acid, alpha linolenic acid, lignoceric acid, arachidic acid, gondoic acid, oleic acid, vaccenic acid, palmitoleic acid, eicosadienoic acid, linoleic acid, margaric acid, gondoic acid, erucic acid, palmitoleic acid, heptadecenoic acid, or myristic acid, or any isomers thereof, or any combination of the foregoing.

12. The composition of claim 11, wherein the composition comprises at least 40% oleic acid.

13. The composition of claim 1, wherein the color of the composition is yellow or light yellow as determined by the Lovibond Color—AOCS Scale using a 1-inch cell path, wherein:
when the composition is yellow, the composition has a Lovibond Color Y-value of greater than or equal to 25; and
when the composition is light yellow, the composition has a Lovibond Color Y-value of less than 25.

14. The composition of claim 1, wherein the composition has one or more sensory attributes selected from the group consisting of: nuttiness, butteriness, grassiness, smoothness, and sweetness, and any combinations thereof.

15. The composition of claim 1, wherein the composition has a ratio of karanjin to pongamol of greater than about 1.

16. (canceled)

17. The composition of claim 1, wherein the color of the composition is light yellow as determined by the Lovibond Color—AOCS Scale, and wherein the composition comprises less than or equal to about 200 ppm karanjin and pongamol combined as determined by HPLC-DAD analysis of an acetone extract obtained from the Pongamia oil composition.

18. The composition of claim 1, wherein the composition has a neutral flavor.

19. The composition of claim 1, wherein the composition has a ratio of karanjin to pongamol of less than or equal to 1.

20. The composition of claim 1, wherein the composition has:
(i) a free fatty acid content of less than or equal to about 1%;
(ii) less than or equal to about 0.1% of insoluble impurities;
(iii) less than or equal to about 25 ppm of phosphorus;
(iv) less than or equal to about 0.1 ppm of chlorophyll;
(v) a moisture content of less than or equal to about 1%;
(vi) less than or equal to about 1% glycerol;
(vii) less than or equal to about 2% monoglycerides;
(viii) less than or equal to about 5% diglycerides; and
(ix) at least about 90% triglycerides
(x) or any combination of (i)-(ix).

21. (canceled)

22. A method for producing a Pongamia oil composition, comprising:
mechanically separating dehulled Pongamia oilseeds to produce crude Pongamia oil and a seedcake that is at least partially deoiled, wherein the crude Pongamia oil comprises Pongamia oil, karanjin, pongamol, other furanoflavonoids, and other unsaponifiable matter; and
extracting the crude Pongamia oil with ethanol at an elevated temperature to produce the Pongamia oil composition, wherein the ratio of solvent to crude Pongamia oil is between 1:1 and 20:1, and wherein the composition is edible and non-bitter tasting, has less than or equal to about 1000 ppm of karanjin and pongamol combined as determined by HPLC-DAD analysis of an acetone extract obtained from the Pongamia oil composition; less than or equal to about 1% by weight of unsaponifiable matter; a peroxide value of less than or equal to about 5 meq/kg; and a p-anisidine value of less than or equal to about 10.

23. (canceled)

24. A continuous countercurrent method for producing a Pongamia oil composition, comprising:
a) mechanically separating dehulled Pongamia oilseeds to produce crude Pongamia oil and a seedcake that is at least partially deoiled,
wherein the crude Pongamia oil comprises Pongamia oil, karanjin, pongamol, other furanoflavonoids, and other unsaponifiable matter;
b) separating the crude Pongamia oil into a raffinate and a solvent-rich light phase by liquid-liquid extraction using immiscible solvent at an elevated temperature,
wherein the ratio of solvent to crude Pongamia oil is between 1:1 and 20:1,
wherein the raffinate comprises Pongamia oil and residual solvent,
wherein the solvent comprises ethanol, and
wherein the solvent-rich light phase comprises solvent and residual Pongamia oil;
c) cooling the raffinate to separate the residual solvent from Pongamia oil;
d) isolating at least a portion of the Pongamia oil in the cooled raffinate to produce the Pongamia oil composition,
wherein the composition is edible and non-bitter tasting, has less than or equal to about 1000 ppm of karanjin and pongamol combined as determined by HPLC-DAD analysis of an acetone extract obtained from the Pongamia oil composition; less than or equal to about 1% by weight of unsaponifiable matter; a peroxide value of less than or equal to about 5 meq/kg; and a p-anisidine value of less than or equal to about 10;
e) separating at least a portion of the solvent from the solvent-rich light phase; and
f) combining the isolated solvent with additional crude Pongamia oil for liquid-liquid extraction.

25-38. (canceled)

39. A Pongamia oil composition produced according to the method of claim 24.

40. (canceled)

41. A food or beverage product, comprising the Pongamia oil composition of claim 1.

42-43. (canceled)

44. The product of claim 41, wherein the product is salad oil, frying oil, sauteeing oil, vinaigrettes, sauces, dressings, fats in meat mimetics, beverages, or blended margarines and other solid fat applications.
